(19) United States
(12) Patent Application Publication
(10) Pub. No.: US 2004/0193439 A1
(43) Pub. Date: Sep. 30, 2004

(54) Method and system for versatile automated commissioning tools

(76) Inventor: Alan V. Marrott, Greenwood Village, CO (US)

Correspondence Address: Merchant & Gould P.C., P.O. Box 2903, Minneapolis, MN, 55402-0903, US

(21) Appl. No.: 10/773,842

(22) Filed: Feb. 6, 2004

Related U.S. Application Data
(60) Provisional application No. 60/445,856, filed on Feb. 8, 2003.

(51) Int. Cl. G06F 17/60

(52) U.S. Cl. 705/1

(57) ABSTRACT

A method and system for versatile automated commissioning tools providing an automated process for calculating commissions on a reoccurring basis under a plurality of user defined commission plans. In one illustrative embodiment, the automated process entails receiving a request to calculate commissions for a specific instance and then identifying the commission plans having commissions owing and calculable for the specific instance. Once the plans have been identified, the process next comprises importing the appropriate sales records from an external source and calculating commissions for recipients named in connection with the commission plans. To calculate the commissions for a commission plan, one or more user defined queries specific to the commission plan are applied to the imported sales records to manipulate the sales records and to extract the desired sales figures. After extraction, the sales figures are dynamically incorporated into an arithmetic expression previously defined by the user whereby the commission for each of the recipients is calculated. Once the commissions have been calculated for the specific instance, the commissions for another specific instance may be calculated with little or no further input required from the user.

In another illustrative embodiment, the user defines the terms and criteria by which the commissions will be calculated through a graphical user interface. The graphical user interface allows an unsophisticated user to define the parameters of the various aspects of the present invention without an extensive knowledge of a programming language. The parameters entered by the user are then saved in a table format, thereby allowing them to be accessed easily and efficiently. Notably, a three-tiered architecture allows the deployment of the present invention in a single computer setting or a networked environment.

### CROSS-REFERENCE TO RELATED APPLICATIONS

This application claims priority of U.S. provisional application Serial No. 60/445,856, filed Feb. 8, 2003.

### STATEMENT REGARDING FEDERALLY SPONSORED RESEARCH OR DEVELOPMENT

Not Applicable.

### BACKGROUND OF THE INVENTION

1. The Field of the Invention

The present invention relates generally to a method and system for calculating commissions, and more particularly, but not necessarily entirely, for an automated method and system to calculate commissions on a reoccurring basis.

2. Description of Related Art

Commission management is a hot button issue for companies competing in today's dog-eat-dog marketplace and is crucial to success in the marketplace. Companies that inadequately manage their compensation invariably begin to lose profits, customers, and ultimately sales personnel. Despite the importance of effective commission management, most companies are finding it increasingly difficult to accurately and timely calculate the commissions due their sales force.

It has been estimated that commissioned employees receive the wrong compensation up to 40% of the time in some industries. The results of these inaccuracies can be disastrous, some of which include, higher corporate overhead, sales personnel downtime, low morale, high employee turnover, increased employee training costs, and lower customer satisfaction. Such inaccuracies in calculation of commissioned compensation can be magnified several times over in industries that sell not only physical products, but offer a wide range of services based upon those physical products, such as in the communications industry. In addition, companies often employ multiple sales channels, such as direct sales, telemarketers, inbound call centers, and independent sales organizations, each of which may have several distinct commission plans. Further complicating the incentive calculation management process is that each channel may additionally have different commission plans that apply to the individual employees within the channel. For example, a manager may receive his or her commission based on the sales of the subordinate employees, while the employees receive compensation based upon their actual sales.

Typically, the process of calculating commissions in large organizations requires the use of several people gathering the sales data from spreadsheets and crude databases recording the performance from the various sales channels utilized by a company. In the case that the sales data is stored in a database, the data is typically extracted by running a report on the database for the time period for which the commissions will be paid. The report is generally created by using a query. A query is a tool used to manipulate data in a database. However, composing a query often requires special knowledge outside the skills of the individual or individuals assigned the task to calculate the commissions. Thus, composing a query may require employing additional individuals to create the query.

Once the report based upon the query has been run, however, the commissions still need to be calculated. Often, the extracted data is manually entered or imported into a spreadsheet program, such as MICROSOFT□ EXCEL□, and the commissions are calculated using the tools provided by the spreadsheet. The lack of an integrated method to extract sales data from a database and calculate the commissions in a single process allows for the entry of errors into the process. Further, since the process is not automated, the process must be repeated indefinitely, often on a weekly or bi-weekly basis. Further compounding the problem is that individual sales channels may organize their own sales data and send it to the department in charge of calculating the commissions. The process often requires several weeks, and leads to a high calculation error rate. Some of the deficiencies of the above described process include generic calculations, costly implementations, constant and costly maintenance, and weak calculation capabilities.

The inherent errors found in the above-described processes lead to a general mistrust of the endeavor of calculating commissions. Considerable selling time is lost while sales personnel track calculations and attempt to resolve errors, whether the errors are real or imagined. Further, the error tracking process itself on the part of the by the sales personnel is time consuming and wasteful. Error tracking usually draws upon several departments within a given company and therefore ties up multiple resources.

Another problem in calculating commissions is that under the currently available methods is the very task of determining and implementing the commission plan in the first place. Sales campaigns and promotions must be designed and deployed quickly. Organizations often employ business analysts to determine the profitability of a product based upon the commission paid to the sales personnel, these analysts generally calculate several “what if” scenarios. This process may take several weeks due to the manual nature of the process thereby delaying the entry of the product or campaign into the marketplace. Often, however, analysts may find that they are handcuffed due to the inability of the organization to handle a complex compensation structure. For example, if the analysts determine that a commission structure that is too difficult to implement due to its complexity or the short time available to implement the plan, then the organization will not do so, thereby, depriving the organization with an enhanced source of revenue. Often an organization may want to pay one-time payouts or bonuses, but are unable to do so due to the limitations of its current system of calculating the commissions.

Further, critical to the success of a campaign or promotion is the sales force's understanding of the compensation they will receive for their efforts. This is sometimes difficult because new commission plans must be designed and deployed quickly. Often, sales personnel are promised an additional incentive to sell a particular product or service, only to find that the additional incentive was not added in time to be reflected in their paycheck. The fact that sales personnel do not promptly see their commission reflected in their paycheck disadvantageously works as a disincentive to performance of the entire sales force.

It would be advantageous to provide a method and system which overcomes the problems identified above, which include, among other things, the piecemeal and timely process of calculating commissions through existing methods, the manual calculating of commissions, the inability to rapidly deploy new commission plans, the grueling nature of calculating commissions on a reoccurring basis, and the ability to simultaneously employ a plurality of different commission plans.

It is therefore desirable to provide an automated method and system for managing the commissions of a sales force by accommodating complex product offerings and multiple commission plans in a timely and efficient manner on a reoccurring basis.

### BRIEF DESCRIPTION OF THE DRAWINGS

The features and advantages of the invention will become apparent from a consideration of the subsequent detailed description presented in connection with the accompanying drawings in which:

FIG. 1 is a diagram depicting a general logical overview of the elements of a first embodiment of the present invention.

FIG. 2 is a diagram depicting a general logical overview of the elements of a second embodiment of the present invention.

FIG. 3A is a diagram illustrating the relationship of one component and one commission plan.

FIG. 3B is a diagram illustrating the relationship of one component and a plurality of commission plans.

FIG. 3C is a diagram illustrating the relationship of a plurality of components and one commission plan.

FIG. 3D is a diagram illustrating the relationship of one component and a look-up table and a tiered look-up table.

FIG. 4 is a diagram representing the different types of components.

FIG. 5 is a diagram illustrating the flow of the sales data from the sales records through a predefined function and into a look-up table or a tiered look-up table.

FIG. 6 is a diagram representing one arrangement of the structures of an illustrative embodiment of the present invention.

FIG. 7 is a diagram representing the flow of data through the various tables as processed by one embodiment of the present invention.

FIG. 8 is a flow chart showing the steps carried out in accordance with one illustrative embodiment of the present invention to define a commission policy.

FIG. 9 is a flow chart showing the steps carried out in accordance with one illustrative embodiment of the present invention to define a commission plan.

FIG. 10 is a flow chart showing the steps carried out in accordance with one illustrative embodiment of the present invention to define a component.

FIG. 11 is a flow chart showing the steps carried out in accordance with one illustrative embodiment of the present invention to define a look-up table.

FIG. 12 is a flow chart showing the steps carried out in accordance with one illustrative embodiment of the present invention to define a tiered look-up table.

FIG. 13 is a flow chart showing the steps carried out in accordance with one illustrative embodiment of the present invention to calculate the commissions.

FIG. 14 is a flow chart showing the steps carried out in accordance with one illustrative embodiment of the present invention to calculate the commissions on a reoccurring basis.

FIG. 15 is a flow chart showing the steps carried out in accordance with one illustrative embodiment of the present invention to calculate the commissions.

FIG. 16 is a flow chart showing the steps carried out in accordance with one illustrative embodiment of the present invention to calculate the commissions using a graphical user interface.

FIG. 17 is a flow chart showing the steps carried out in accordance with one illustrative embodiment of the present invention to calculate the commissions.

FIG. 18 is a flow chart showing the steps carried out in accordance with one illustrative embodiment of the present invention to calculate the commissions using an organizational hierarchy.

FIG. 19A-H is a detailed diagram showing the components of one illustrative embodiment of the present invention.

### DETAILED DESCRIPTION OF THE ILLUSTRATIVE EMBODIMENTS

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

It must be noted that, as used in this specification and the appended claims, the singular forms “a,” “an,” and “the” include plural referents unless the context clearly dictates otherwise.

In describing and claiming the present invention, the following terminology will be used in accordance with the definitions set out below.

As used herein, “comprising,” “including,” “containing,” “characterized by,” “having,” and grammatical equivalents thereof are inclusive or open-ended terms that do not exclude additional, unrecited elements or method steps.

As used herein, the term “engine” refers to, in the abstract or logical sense, as something used to achieve a desired purpose. In the computer software context, an engine refers to a piece of software code, or its equivalents, and its interaction with the computer hardware and optionally data that is used to achieve some desired result. For the purposes of this invention, both definitions of the term “engine” may be used as will be ascertained from the context in which the term is presented.

As used herein, the term “commission” refers to any fee, incentive compensation, share, bonus, compensation, cut, payment, royalty or percentage allowed for services rendered, including without limitation, sale of a product, a service, a reoccurring service, or a completed task, such as collection efforts. The term “commission” also refers to an override paid to a superior, upline, manager, or any other member of a hierarchy, based upon the performance of others. Furthermore, the term “commission” also refers to future or hypothetical commissions calculated for business analysis under “what if” scenarios.

As used herein, the term “product” refers to any commodity or service upon which a commission is based, including without limitation, transactions involving tangible and intangible goods and services of any kind, whether sold on a one time basis or a reoccurring bases, or any other thing upon which a commission may be based and calculated.

As used herein, the term “sales record” refers to a compilation of data reflecting the particulars of one or more transactions on which a commission can be paid. Sales records may include records from any source, including without limitation, an order entry system or a billing system. A sales record is typically, but not necessarily, stored as a logical row in a database table and is comprised of a plurality of fields.

As used herein, the term “table” or “database table” refers to a logical arrangement of data having rows and columns and being stored in an electronic format. The term “table” may also refer to an non-electronic format if the context in which the term is presented so permits.

By way of introduction only, and by no means limiting the scope or breadth of the present invention, from an examination of the disclosure provided herein those skilled in the art will appreciate that illustrative embodiments of the present invention advantageously and automatically extract sales figures from a database table comprised of sales records and determine the commissions owing for named recipients in a single integrated and automated process. Thus, the present invention automates previously manual tasks into one single integrated process. Moreover, the present invention allows commissions to be calculated on a reoccurring basis without having to “reconfigure” for each new instance for which the commissions are to be calculated. In effect, the present invention provides a convenient platform to solve many of the problems existing in methods and systems currently in use.

By way of further introduction and by no means limiting the scope of the present invention, depending on the particular features of the embodiment of the present invention employed, a user defines parameters by which the commissions will be calculated. The parameters may, for example, define who receives the commissions, how often the commissions are paid, the structure for which the commissions will be paid, and the data used to calculate the commissions. If the particular embodiment allows, commissions may be calculated on a reoccurring basis with little or no effort by the user once the criteria for calculating the commissions have been established by the user.

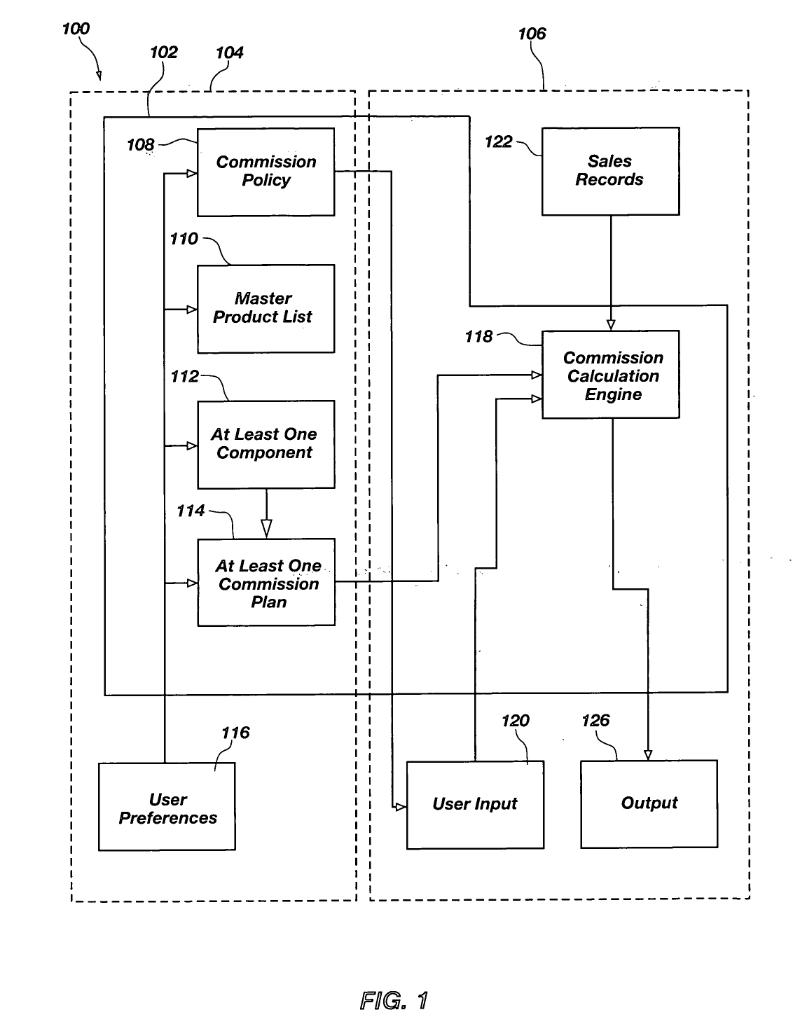

Referring now to the figures that will describe several illustrative embodiments of the present invention, FIG. 1 depicts a general logical overview, generally indicated at 100, of one illustrative embodiment of the present invention. The overview 100 is divided into two conceptual phases, a setup phase, represented by box 104, and a run phase, represented by box 106. The setup phase 104 represents the acceptance of a system, as indicated by the outline 102, of user preferences 116 pursuant to the format dictated by the system 102, said user preferences 116 forming the criteria and rules by which the commissions will be calculated. It will be appreciated that the user preferences 116 will vary from deployment to deployment—the user preferences 116 being dictated by, among other things, the type of products sold, the sales channels utilized, commission rates and structure, and the organization of any databases containing the sales records 122. Indeed, one of the significant advantageous features of the present invention is the flexibility afforded the user to define the criteria by which the commissions will be calculated. In particular, during the setup phase 104, the system 102 accepts the user preferences 116 to thereby define a commission policy 108, a master product list 110, at least one component 112, and at least one commission plan 114.

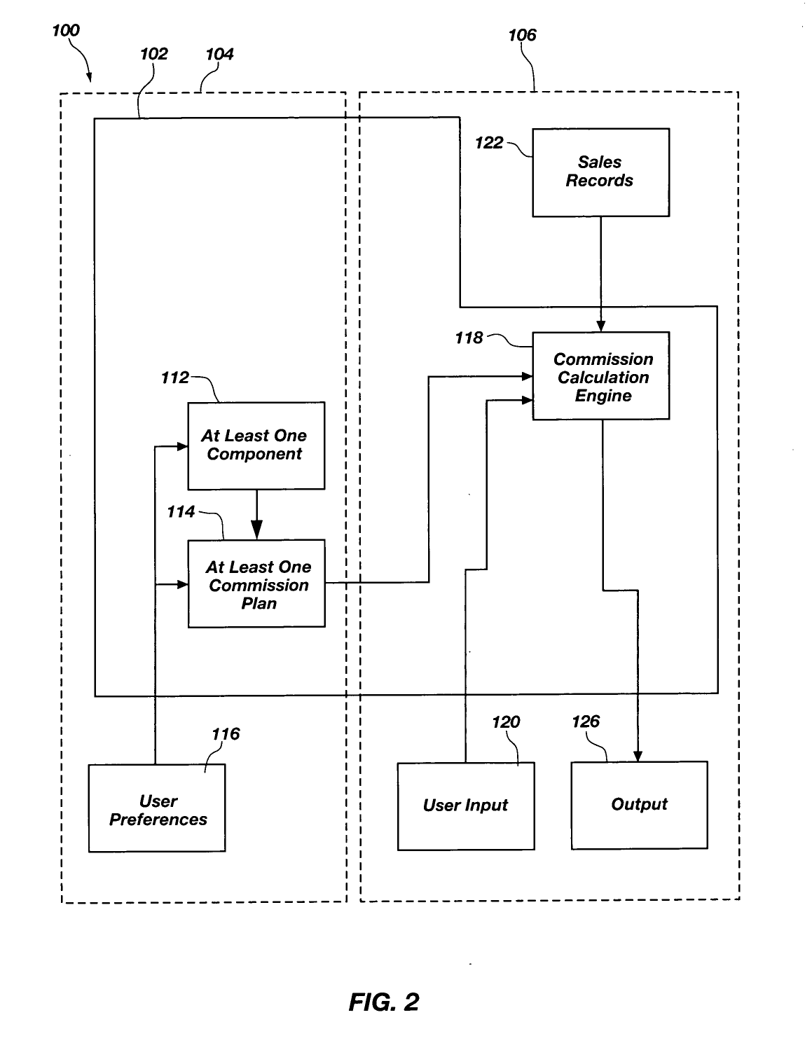

In another illustrative embodiment as shown in FIG. 2, the system 102 accepts user preferences 116 to define at least one component 112 and at least one commission plan 114. Those skilled in the art will recognize the additional embodiments of the present invention which can be derived using the information set forth herein, all of which are intended to fall within the scope of the present invention. The purpose and function of the commission policy 108 (see FIG. 1), master product list 110 (see FIG. 1), at least one component 112 (see FIGS. 1 and 2), and at least one commission plan 114 (see FIGS. 1 and 2) will now be described in greater detail. It should be noted that the terminology of “a commission policy”, “a master product list”, “a component”, or “a commission plan” is not intended to be limiting and that many other terms can be used within the scope of the present invention by corresponding and equivalent structures and steps. The terms used herein are selected to assist in the clear description of each of the embodiments of the present invention. It is sufficient, that if a method or system has the features or functionality of the any of the above named and below described elements, that method or system is to be considered as possessing that element or the equivalent thereof.

Further, as made clear by the elements not included in FIG. 2 but which are represented in FIG. 1, not every embodiment of the present invention will have all of the above named elements. It should be appreciated that each element adds a greater degree of functionality and usefulness to an embodiment of the present invention, and that in some cases, a lesser degree of functionality and usefulness may suffice for a particular user. Further it should be noted that each of the above named elements may be embodied in several different arrangements, as will described hereinafter. Of similar import is that each of the above named elements may be created or deployed in several different manners by one skilled in the art, some of which will be described herein, without departing from the scope of the present invention.

Commission Policy

Returning to the embodiment illustrated in FIG. 1, the commission policy 108 determines the schedule or structure by which the commissions will be calculated. In other words, the commission policy 108 constrains the calculation of the commission to specific instances. The commission calculation engine 118 can only be invoked for these specific instances. The specific instances can be specific dates, weeks, months, or other periods as determined by the user preferences 116. In one illustrative embodiment of the present invention, the user preferences 116 comprise a frequency and a start date. The system 102 can then find the allowable specific instances based upon the frequency and start date. The specific instances in this exemplary case will be specific dates. For example, if the user preferences 116 specifies a weekly frequency and a start date of Saturday, then the user is allowed to invoke the commission calculation engine for every Saturday. In another embodiment, the user preferences 116 select or identify the specific instances without the system 102 generating the specific instances. In still another embodiment, the system 102 has predetermined the specific instances for which the commissions can be calculated.

The commission policy 108 is often, but not necessarily, dictated by the actual paydays of the user. If the user's paydays are weekly, then the user may define the commission policy 118 as having weekly frequency. Thus, commissions will also be calculated weekly. It should be noted, however, that not all of the embodiments of this invention require a commission policy as shown in FIG. 2. In the embodiment shown if FIG. 2, the user is allowed to determine, without limitation, the instances for which the commissions will be calculated.

It should further be noted that the commission policy 108 does not necessarily determine the date range for which the commissions will be calculated. As will be described in greater detail below each of the at least one commission plan 114 determines the date range or date ranges for which that plan's commissions will be calculated.

However, the commission policy 108 may optionally determine the date range for which the commissions are calculated. In this option, the commissions for all of the at least one commission plan 114 are calculated for the same date range. In the case where an embodiment does not have a commission policy 108, such as shown in FIG. 2, the date range for which the commissions are calculated may depend solely on the date range spanned by the sales records 122 provided to the system 102.

It is important to note that any method, system or apparatus constraining the calculation of the commissions to specific instances should be considered as having a commission policy 108 no matter how that policy comes about or what terminology is used to describe the equivalent function. It will be appreciated that calculating the commissions pursuant to the commission policy 108 provides accuracy, organization and reliability to the commission calculation process in contrast to calculating the sales commissions on an ad hoc basis.

Master Product List

The master product list 110 has many beneficial uses in the commission calculation process. However, not every embodiment of the present invention will have a master product list 110 as can be seen by comparison of the embodiment represented in FIG. 1 and the embodiment represented in FIG. 2. The master product list 110 is also optional in the embodiment represented in FIG. 1, but is represented therein for to provide a discussion of the principal benefits of the present invention.

One of the beneficial uses of the master product list 110 is the ability to integrate the present invention with any existing external source of sales records 122. Often, the source of the sales records 122 may not identify products by name. For example, Table 1 contains a sample master product list. Table 2 contains sample sales records obtained from an independent system identifying the products by codes.

TABLE 1

| | | Product | |
|---|---|---|---|
| Product Name | Work Order Type | Code | Option Flag |
| The Works | Upgrade | ABC | HBW |
| Gold Package | New Connect | PREM | FLG |
| Gold Upgrade | Upgrade | PREM | FLG |
| Silver Package | New Connect | AO | |
| Basic Package | New Connect or Reconnect | BASIC | T2 |

TABLE 2

| Sales ID | Work Order Type | Product Code | Option Flag |
|---|---|---|---|
| 101 | Upgrade | BASIC | T2 |
| 102 | New Connect | BASIC | T2 |
| 103 | Upgrade | ABC | HBW |
| 104 | Upgrade | PREM | FLG |
| 105 | New Connect | PREM | FLG |
| 106 | New Connect | AO | |
| 107 | Upgrade | AO | MLK |

Comparing the appropriate columns in Table 1 to the entries in Table 2, the product sold by each Sales ID can be easily determined, as shown in Table 3 below.

TABLE 3

| Sales ID | Product Sold |
|---|---|
| 101 | Basic Package |
| 102 | Basic Package |
| 103 | The Works |
| 104 | Gold Upgrade |
| 105 | Gold Package |
| 106 | Silver Package |

It will be appreciated from the example provided in Tables 1-3, that the use of the master product list 110, or its equivalent, eliminates the need to make changes to the external source, i.e., an order entry system, a billing system or other valid source of sales records thereby allowing an illustrative embodiment of the present invention to be easily integrated with any of order entry system, billing system or other sales records source, or their equivalents, which is now available or which become available in the future.

Another beneficial use of the master product list 10 is that it can also serve the function of being used to validate the sales records 122 for completeness and lack of errors. Due to the fact that the sales records 122 may originate from a variety of different sources, including without limitation, an order entry system or billing system, the accuracy and completeness of the sales records 122 may not be known. As with any data entry process, errors propagate into the system. In order to validate the completeness of the sales records 122, the master product list 110 is compared to the appropriate entries in the sales records 122. If a particular sales record contained a product name or code not on the master product list 110, then that particular sales record could be flagged has having a potential error. For example, referring back to Tables 1 and 2 above, note that the codes for Sales Id 107 as shown in Table 2 does not correspond to the data contained in Table 1, and therefore an associated product name cannot be identified. In this instance, the particular sales record could be flagged for further review. Such ready error identification was beyond the scope of previously available systems and methods.

Still another use of the master product list 110 is to supply a list of products to the at least one component 112 in the appropriate circumstance. In particular, the master product list 110 can be utilized as a source to populate look-up tables, such look-up tables being illustrative of one type of component 112 which can be implemented within the scope of the present invention, as will be described in greater specificity below.

Components

Referring again to FIGS. 1 and 2, the at least one component 112 comprises one or more components as dictated by the user. As used herein, the term “component” refers to an application that interacts with a database, such as a database table, containing sales information, such as sales records, to return a result that is useful in the calculation of commissions.

Illustratively, the result is stored in a second database table. Typically, but not necessarily, each of the at least one component 112 is used to extract sales figures in the form of a numerical amount, such as a total sales amount in dollars or quantity, from the sales records 122, the sales records 122 being illustratively stored in the format of a database table.

As used herein, the term “sales figures” means any useful data in the commission calculation process than can be extracted from a database. The sales figures may include, but are not limited to, numerical values or product names.

Further, the sales figures may include groupings. For example, the sales figures can include the name or ID of a salesperson.

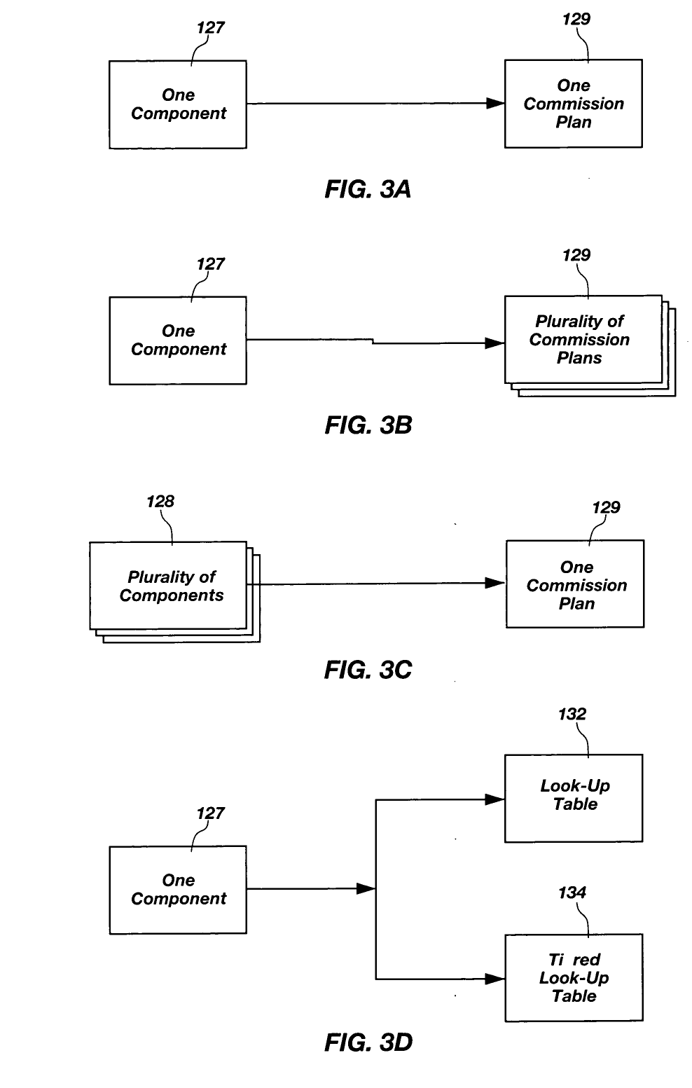

Each of the at least one component 112 can be used in a plurality of different configurations as determined by the user, a representative sample of which will now be explained. As illustrated in FIG. 3A, one component 127 can be used individually by one commission plan 129. FIG. 3B illustrates that one component 127 can be used by a plurality of commission plans 130. FIG. 3C further illustrates that a plurality of components 128 can be used by one commission plan 129; or as illustrated in FIG. 3D, one component 127 can be used to as a data source for a look-up table 132 or a tiered look-up table 134, look-up tables and tiered look-up tables both being types of components.

Briefly stated here and explained in further detail below, each of the at least one commission plan 114 (FIGS. 1 and 2) utilizes components to supply data to a variable contained in a commission rule. The commission rule is then solved to find the commissions due under the plan. All of the above-described configurations relating to components, and many more which can be derived by those skilled in the art using the information provided herein, are contemplated within the scope of the present invention.

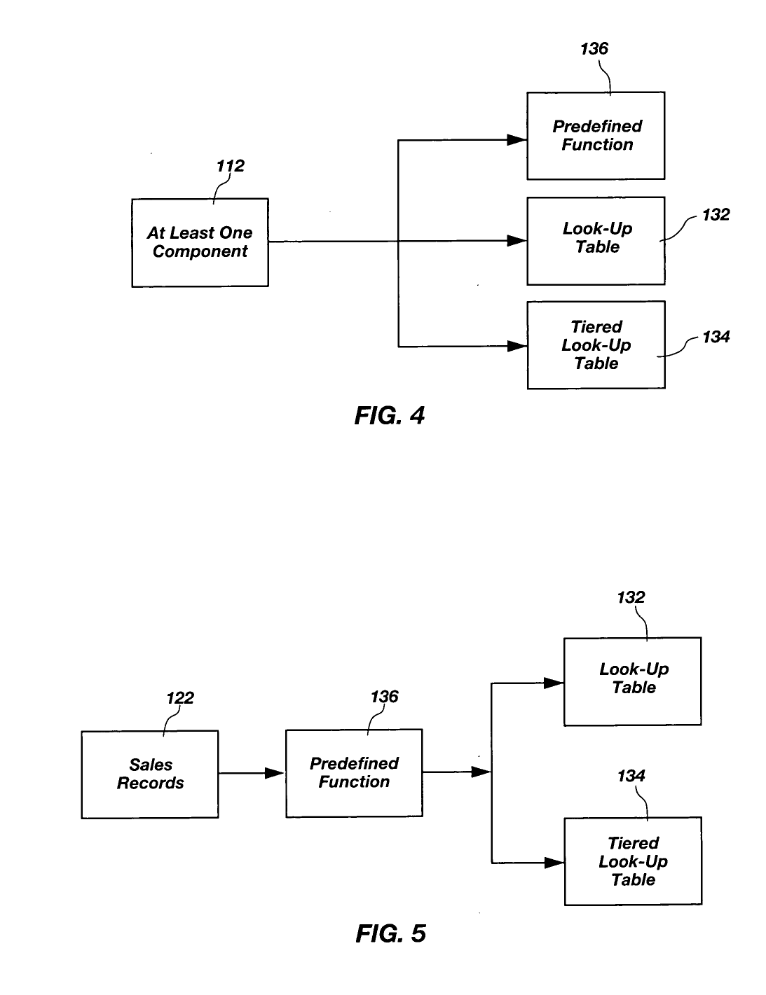

In the embodiments illustrated in FIGS. 1 and 2, each of the at least one component 112 is chosen from one of three illustrative component types, as represented in FIG. 4: A predefined function 136; A look-up table 132; and, A tiered look-up table 134. Again, it should be noted that the use of the terms “a predefined function,” “a look-up table,” or “a tiered look-up table” are not intended to be limiting of the scope of the present invention. These terms are used herein to provide a clear explanation of the principal features of the illustrative embodiments of the present invention. It is sufficient that a method or system includes the features or functionality of the any of the above recited terms and elements and/or the below described components, and if so, the method or system at hand is to be considered as possessing that feature corresponding to that term, element or component within the scope of the present invention.

Referring again to FIGS. 1 and 2, in one illustrative embodiment of the present invention, the user preferences 116 define each of the at least one component 112 through a interactive graphical user interface (GUI), as is known in the art. In alternative embodiments, the user creates the components using a programming language, as is also well known in the art. It will be appreciated and understood by one skilled in the art that both accomplish the same result and should be viewed as equivalent and within the scope of the present invention.

Predefined Function

A predefined function 136 is used to manipulate and perform operations on the sales records 122 to return a useful result, typically sales figures, pursuant to the user preferences 116. As previously mentioned, the sales records 122 (see FIGS. 1 and 2) are typically stored in a database table, the database table being comprised of columns, which comprise the sales record fields, and rows, which contain a single sales record. A predefined function 136 is capable of performing on the database table containing the sales records 122, either separately or in combination, a manipulation (as defined by the user) to extract the sales figures needed to calculate the commissions. The results of this manipulation are illustratively placed in a separate database table, such as an output table (not explicitly represented in the figures). As a particular example, a predefined function 136 utilizes a query to interact with the database table (not explicitly represented in FIG. 4). Queries are flexible tools to request information from a database and are well known to those skilled in the art. Queries are composed using a query language, such as SQL (structured query language) available from a number of vendors in the marketplace.

The following examples are helpful for illustrative purposes only to understand the function and purpose of a predefined function 136 (FIG. 4). Table 4 below contains an example of sales records that can be provided to a predefined function for manipulation. As can be easily ascertained from the table, each sales record contains the name of the salesperson, the product name, the quantity sold, and the revenue from the sales and additional information can also be provided within the scope of the present invention.

TABLE 4

| Name | Product ID | Sales | Revenue |
|---|---|---|---|
| John | Channel 1 | 5 | $100 |
| John | Channel 2 | 10 | $50 |
| John | Channel 1 | 30 | $75 |
| Mary | Channel 1 | 15 | $200 |
| Mary | Channel 2 | 20 | $150 |

In the context of a predefined function (136 in FIG. 4), the user can specify that the “Revenue” column be summed and grouped by “Name.” In this instance, the output table would contain the sales figures “John $125” and “Mary $350.” In addition, the user could further specify a filter to exclude certain sales records from consideration. For example, the user could specify that the predefined function only consider the entries in the “Product ID” column when equal to “Channel 1.” In this instance, a second output table (using the exemplary sales data from Table 4) would contain the sales figures “John $175” and “Mary $200.”

It should be noted the sales figures obtained from the sales records provided herein, such as the sales figures provided in Table 4) are not intended to represent the typical commissions earned in actual practice but are useful for providing clear and descriptive examples. In the case of the above provided examples, the sales figures would be fed into a commission plan, and more particularly, a commission rule, to determine the commissions to be paid to the salespeople. For example, if the commissions were paid on 10% of sales, then the commission rule would return a result of 10% of the total revenue.

It should be noted that the examples provided herein are for illustrative purposes only, and should not be construed to limit the scope of the present invention in anyway. It will be appreciated that through the use of a predefined function (136 in FIG. 4), the user is advantageously afforded a wide range of flexibility in manipulating the sales records 122 to extract any sales figures needed to calculate the commissions.

Look-Up Table

A look-up table (132 in FIGS. 4 and 5) matches an entry in a sales record field to one of the entries in a list of attributes having an award value, such as a dollar amount. When a match is made, then the award value is awarded to the appropriate recipient. It should be noted that if the award value is based upon product name, that the master product list (110 in FIG. 1) may be employed to ascertain the product name from the sales record field as described above. The use and purpose of a look-up table 132 is demonstrated by the following illustrative example. Using Table 3, above, and Table 5 (which is a look-up table), below, each sales ID is assigned an award amount as shown in Table 6. This is accomplished by matching the product name in each row of Table 3 to the list of attributes to find the award value.

TABLE 5

| Attribute | Award Value |
|---|---|
| The Works | 5.00 |
| Gold Package | 6.00 |
| Gold Upgrade | 7.00 |
| Silver Package | 8.00 |
| Basic Package | 9.00 |

TABLE 6

| Sales ID | Awarded Amount |
|---|---|
| 101 | $9.00 |
| 102 | $9.00 |
| 103 | $5.00 |
| 104 | $7.00 |
| 105 | $6.00 |
| 106 | $8.00 |

It should be noted that the awarded amount is not necessarily the commission to be paid to the employee. The information in Table 6 is most often used by a commission rule to determine the commission to be paid to a particular employee for the particular sales transactions.

Tiered Look-Up Table

A tiered look-up table 134 (see FIG. 4) attributes an award amount based upon a quantitative number in comparison with ranges of values. The quantitative number is contained in each of the sales records 122 (see FIGS. 1 and 2) or is derived from the sales records 122 by a predefined function 136. Each of the range of values and its associated award amount is determined by the user. The use and purpose of a tiered look-up table 134 is demonstrated by the following illustrative example.

Each row in Table 7, set forth below, contains a quantity of sales for the associated sales ID. Table 8, a tiered look-up table, contains ranges of values and associated award amounts. Table 9, is obtained by comparing the quantity of sales in each row of Table 7 to the ranges in Table 8 and awarding the appropriate award amount.

TABLE 7

| Sales ID | Quantity of Sales |
|---|---|
| 101 | 10 |
| 102 | 51 |
| 103 | 101 |
| 104 | 200 |
| 105 | 225 |
| 106 | 325 |

TABLE 8

| Range | Award Amount |
|---|---|
| 1-50 | 50.00 |
| 51-100 | 100.00 |
| 101-200 | 150.00 |
| 201-300 | 200.00 |
| 301-400 | 250.00 |
| 400-1000 | 300.00 |

TABLE 9

| Sales ID | Awarded Amount |
|---|---|
| 101 | $50.00 |
| 102 | $100.00 |
| 103 | $150.00 |
| 104 | $150.00 |
| 105 | $200.00 |
| 106 | $250.00 |

It should be noted that the awarded amounts in Table 9 are not necessarily the commissions. The information in Table 9 could be used by a commission rule to determine the commissions paid to the respective salespersons. For example, a commission rule could specify that the commissions are 10% of the awarded amount. While the above provided examples greatly simplify the process and should not be used to construe or narrow the scope of the present invention or limit the what is to be considered an embodiment of the present invention, the examples clearly convey the purpose and use of a tiered look-up table 134.

Both the look-up table 132 and the tiered look-up table 134 can be created using an interactive graphical user interface. In an alternative embodiment of the present invention, the tables are created using a programming language as is well known in the art. It will be appreciated that use of an interactive graphical user interface and a programming language both achieve the same function and both of which are within the scope of the present invention.

Advantageously, it is within the scope of the present invention for both a look-up table 132 and a tiered look-up table 134 to use a predefined function 136 as a data source, as shown in FIG. 5. In other words, a predefined function 136 can be used to create an output table from the sales records 122, as described above. An entry in one of the rows of the output table can then be used to find an award amount from either a look-up table 132 or a tiered look-up table 134, as represented in FIG. 5.

Commission Plan

The at least one commission plan 114 (see FIGS. 1 and 2) comprises one or more commission plans as determined by the user. Due to the fact that each of the at least one commission plan 114 differs from another commission plan only by the user preferences, the discussion provided below will discuss a commission plan in general terms. It should be understood that the discussion applies to each of the at least one commission plan 114, either individually or collectively, as dictated by the context.

As used herein, the term “commission plan” refers to the exact rules and conditions under which commissions will be calculated and received by a recipient. A recipient is any individual or other entity entitled to receive commissions, i.e., sales person, supervisor, independent contractor, etc. As noted, the system 102 allows the simultaneous use of a plurality of commission plans. Each commission plan, however, being independent of the other commission plans, and having its own rules and conditions under which commissions for that commission plan will be calculated.

It will be appreciated that the ability of the system 102 to have a plurality of commission plans simultaneously active and determine the commissions for all of the commission plans in one single integrated process is an significant improvement over the existing art. For example, many organizations use different sales channels, each sales channel being subject to its own commission plan. In addition, multiple commission plans may be employed for a single individual, i.e., an individual may receive regular commissions under one commission plan, and receive bonuses under another commission plan. Further, the same individual may be selling two groups of different products, each having commissions payable under a different commission plan. Commission plans may also be used to pay commissions based upon the sales of others, i.e., a manager or a supervisor may get an override on the sales of subordinates. The above examples represent merely a small sampling of the flexibility of the present invention and should not be construed as limiting of the scope of the present invention in anyway. Indeed, one of the significant advantages of the present invention is allowing the user to define a commission plan or a plurality of commission plans to suit the particular needs of that user.

A commission plan is comprised of one or more features which impart the flexibility into the commission plan. In one illustrative embodiment of the present invention, a commission plan comprises a commission rule, a list of primary recipients, and a commission frequency. In an alternative embodiment, a commission plan comprises a commission rule. Each of these features will be described below. It should be noted that a commission plan can be created using a graphical user interface or programmed using a programming language, both of which fall within the scope of the present invention.

If present in the commission plan, the list of primary recipients identifies the recipients of the benefit of the commission plan. It should be noted that the primary recipients are not limited to actual sales personnel or individuals, but may also include, without limitation, managers, supervisors, departments, independent contractors, agents, and any entity or organization entitled to a commission of any kind. The primary recipients may be selected from a previously defined organizational hierarchy. The commission rule implements the business rules of how the sales commissions will be calculated as determined by the user. In most embodiments of the present invention, the commission rule comprises an arithmetic expression; the arithmetic expression comprised of at least one variable, and optionally, numerical values and mathematical operators as determined by the user. Each of the at least one variable receives values from a component from the sales records 122. The user is able to define which component supplies data for the variable. In particular, the user may also be required to specify the column in the output table created by the component to supply the values to the variable. In one illustrative embodiment of the present invention, the commission rule is applied to the rows of an output table one row at a time, using the entry in the column identified by the user. In this manner, the commission rule maintains the grouping of the output table. For example, if the output table is grouped by sales representative, i.e., the output table contains one row for each sales representative, then the commission rule will determine the commissions for each of the sales representatives because it is applied row by row. It will also be appreciated that the use of the variable is to allow the commission rule to be applied multiple times, as in the above example, to multiple rows. Once the variable has been supplied with a value, the commission rule is then solved to determine the commissions. After the commission rule has been solved, then the commissions can be appended to the output table, or entered into any number of other tables. In one illustrative embodiment of the present invention, each commission recipient is provided a table, the table indicating the commissions earned under each commission plan. Thus, in accordance with the present invention, the table is updated as commissions for each plan are determined.

The commission frequency defines a repeating interval of time for which the commissions are to be calculated on a regular basis. For example, a user may select to pay commissions on weekly sales, and thus the commission frequency would be weekly. Likewise, the user may select bi-weekly, monthly or any other frequency. The interval of time also determines the date range for which the commissions will be calculated. In this regard, the commission calculation frequency of a commission plan directly correlates the calculation of the sales commissions of a commission plan to the specific instances as determined by the commission policy. Once an interval of time has lapsed, and a new interval begun, the sales commissions for the lapsed interval are owing and calculable and are available for calculation. The calculation of the commissions for the lapsed interval will be assigned to the next specific instance. In one illustrative embodiment of the present invention, the system 102 (see FIGS. 1 and 2) only allows a user to define a commission plan frequency ending on the same day as one of the specific instances defined by the commission policy.

It should be noted that the commission plan frequency need not be the same as the commission policy frequency. A commission policy may for example, dictate that commissions be calculated every two weeks. A commission plan may dictate, on the other hand, that sales commissions based upon that particular plan be calculated monthly. And, as noted previously, not every embodiment of the present invention employs a commission frequency in the commission plan.

Referring now to the illustrative embodiment of the present invention represented in FIG. 2, it should be noted that this embodiment comprises at least one commission plan 114 and at least one component 112, as described above.

Once the user has defined the system 102 pursuant to any of the features of the embodiments represented in FIGS. 1 and 2, the user is able to invoke the commission calculation engine 118 to calculate commissions. User input 120 invokes the commission calculation engine 118 to calculate the commissions. In the case where the embodiment of the present invention comprises a commission policy 108, such as the embodiment represented in FIG. 1, the request to calculate commissions must be for a specific instance as defined by the commission policy 108. If the embodiment does not have a commission policy 108, then the user input 120 simply invokes the commission calculation engine.

When invoked, the commission calculation engine 118 first determines which, if any, of the at least one commission plan 114 has commissions owing and calculable. This may be all, some, or none of the at least one commission plan 114. If the embodiment has a commission policy 108, the commissions must be owing and calculable for the specific instance identified in the user preferences 116. Once these plans have been determined, the commission calculation engine 118 calculates the commissions for each of the commission plans having commissions owing and calculable.

To calculate the commissions for a particular commission plan, the commission calculation engine 118 first gathers the sales records 122 or has the sales records 122 provided to it. The commission calculation engine 118 then applies the components identified in the commission rule to the sales records 122 to thereby extract the sales figures. In one illustrative embodiment of the present invention, if the component is a look-up table 132 or a tiered look-up table 134 (see FIG. 3D), the commission calculation engine 118 applies the predefined function (136 in FIG. 5) serving as the source to the look-up table 132 or a tiered look-up table 134.

The commission calculation engine 118 then applies the commission rule to thereby determine the commissions for each primary recipient listed in the commission plan. The output 126 from the commission calculation engine 118 comprises the calculated commissions for each of the primary recipients of each of the plans having commissions owing and calculable. The output 126 may be stored in one or more tables, printed or exported to another system, such as a payroll system, i.e., the system that actually prints the payroll checks.

In one illustrative embodiment of the present invention, the output 126 (see FIGS. 1 and 2) is reviewed, finalized and/or approved by the appropriate authority before being used to issue a commission payment. This process may include making adjustments to the commissions for any reason. During this process, the output 126 may be reviewed for each individual recipient, or by plan, or any other available grouping.

In another illustrative embodiment of the present invention, the output 126 is made available to authorized personnel for review. Such a review by authorized persons can be performed over a network. For example, a sales representative can be provided with his or her own commissions to review or a supervisor can be provided with the output 126 of his or her subordinates via a network connection. Alternatively, it is within the scope of the present invention to provide review of the output in any other appropriate fashion.

Once the commissions have been calculated, the user is then free to select another instance or any other number of instances for which to calculate the commissions. Normally, the commissions will be calculated in a chronological order and on a reoccurring basis, the only limitation being whether the sales records 122 contain all of the data for the calculation, i.e., all of the records necessary to calculate an accurate commission. It will be appreciated that the system 102 advantageously does not require additional user preferences 116 to calculate the commissions for another instance. However, the user may determine to modify the user preferences 116 prior to a subsequent calculation of the commissions, if desired.

The sales records 122 may be contained in one or more database tables in one or more databases. In addition, the sales records 122 may be contained in an entirely separate system, such as, without limitation, an order entry system or a billing system, as know in the art. Using a billing system as the source of the sales records 122 is generally preferable to that of an order entry system for the following reasons. First, the sales orders may be modified after they are entered into the order entry system for many reasons, such as the customer changes the order. Second, the product may be an ongoing service, such as a mobile/portable (or cell) telephone plan, to which the recipient is entitled commissions as long as the customer continues to subscribe to the plan. Thus, as long as the customer is being billed for the plan, then the recipient can receive an ongoing commission if the billing system is used.

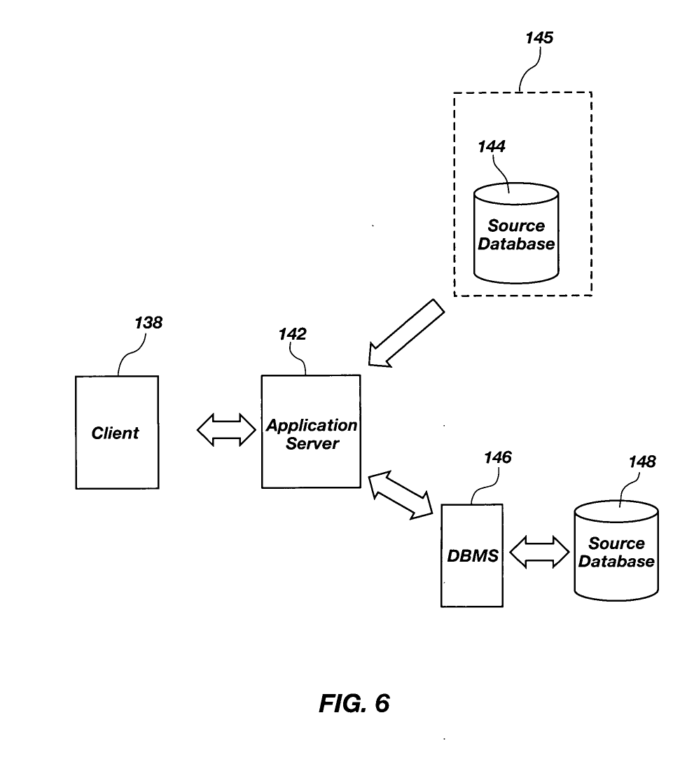

The above provided discussion provides an overview of the primary functions of several different illustrative embodiments of the present invention. Referring now to FIG. 6, there is shown the logical structural components of one illustrative embodiment of the present invention. FIG. 6 illustrates a client 138, an application server 142, an independent system 143, a source database 144, a database management system 146, and a storage database 148. The exemplary relationship between each of these components will now be explained.

The client 138 is typically responsible for receiving and relaying the preferences of the user to the application server 142. The client 138 can trigger the application server 142 to perform any permitted task, such as providing information through the client to the user or calculating commissions. The client 138 is one example of an interface means for receiving user input. It will be appreciated that the client 138 disclosed herein is merely one example of accomplishing the interface means, other suitable arrangements known or readily ascertainable, to those skilled in the art, may be used and are within the scope of the present invention.

The application server 142 is typically event driven and contains all of the business logic and is used to receive and send information to and from the client 138 and is used to retrieve and/or manipulate the data residing in the storage database 148 through the database management system 146.

The storage database 148 contains all data entered through the client 138, such as the parameters defining a commission policy, master product list, component, or commission plan. The storage database 148 may also contain any imported sales records from the source database 144, and any calculated commissions. The storage database 148 is controlled by the database management system 146.

It will be appreciated that the described three tier architecture, i.e., the client 138, application server 142, and database management system 146 and storage database 148, allows each tier to reside in its own physical machine or all tiers can all reside on one physical machine. A physical machine generally comprises a processor, memory and optionally a display. Likewise, it should be understood and recognized by those skilled in the art that any number of clients is permissible within the scope of the present invention, other limitations withstanding, but only one is represented in the illustrative embodiment of FIG. 6.

In one illustrative embodiment of the present invention, the client 138 provides a graphical user interface (GUI) through which the user interacts with the application server 142. As known in the art, a GUI is a program interface that takes advantage of the computer's graphics capabilities to make a program easier to use. It will be appreciated that the GUI simplifies complex tasks and allows an unsophisticated user to perform a wide range of tasks without the need of knowing a computer programming language.

In other illustrative embodiments of the present invention, a command line interface may in accordance with preferences well known in the art. Further, the GUI may be replaced by an equivalent means whether now known or known in the future to assist the user in defining the above named elements. Any interface allowing the user to define the above described elements should be considered within the scope of the present invention.

The primary, but not the only, use of the graphical user interface (GUI), is to allow a user to easily define or modify the criteria and conditions under which the commissions will be paid. In particular, the GUI may allow a user to create or modify a commission policy, a master product list, one or more components, and one or more commission plans without a sophisticated understanding of a programming language. It should be noted that certain embodiments of the present invention may not include all of the above described elements, and thus, not all of the above described elements need be defined or created through the GUI.

The GUI may be used to invoke the calculation of commissions for a particular instance or other system administration, such as creating a commission hierarchy. The GUI may display, but is not limited to, fill-in boxes, drop-down menus, click and choose boxes and push buttons, depending on the information required. When available, the GUI may invoke the application server 142 (see FIG. 6) to provide information stored in tables in the storage database 148 (see FIG. 6). It will be appreciated that the use of a GUI as described above is advantageous over the existing art in allowing a user to easily define the criteria and conditions for which commissions will be paid.

To create a master product list, the GUI solicits the user to enter a product name and any code or codes used to identify that product. The user can repeat this process for as many products as needed. Likewise, the GUI allows the user to modify or search any of the previously entered information relating to the product list. Once defined, the master product list is stored in one or more tables in the storage database 148. The application server 142, database management system 146 and storage database 148 are one example of a validating means for validating the completeness of the sales records through the use of a master product list. It will be appreciated that the validating means disclosed herein is merely one example of accomplishing the validation of the sales records, other suitable arrangements known or readily ascertainable, to those skilled in the art, may be used and are within the scope of the present invention.

An exemplary method for creating a commission policy will now be provided with the understanding that the exemplary method is intended to only be illustrative and not limiting. To create a commission policy, the GUI solicits the user to select a commission payout cycle. The commission payout cycle is the time interval between the instances in which the commissions will be calculated. In one illustrative embodiment, the user is prompted to select the commission payout cycle from a weekly, bi-weekly or monthly cycle. In the case of a weekly commission payout cycle, the user is further prompted to select a starting day from the days of the week. In the case of a bi-weekly commission payout cycle, the user is prompted to enter a starting date. The user may define a commission payout cycle other than those identified above. Once the user has entered the required information, the logic residing on the application server 142 is able to determine from the commission payout cycle and the start day or date and the specific instances for which the commissions can be calculated. The commission policy is stored in the storage database 148. In embodiments of the present invention that do not include a commission policy, no corresponding information need be entered by the user. The application server 142 is one example of a generating means for generating a set of specific instances from a user defined payout cycle. It will be appreciated that the generating means disclosed herein is merely one example of accomplishing the generation of the specific instances, other suitable arrangements known or readily ascertainable, to those skilled in the art, may be used and are within the scope of the present invention.

To create a component, the GUI solicits the user to first select the type of component to create. In one illustrative embodiment, the user may choose from a predefined function, a look-up table or a tiered look-up table. Each of these will be discussed individually below with the understanding that the exemplary method is intended to only be illustrative and not limiting.

In the case of a predefined function, the GUI solicits the user to enter or select a component name, an aggregation column, a function, and optionally a GROUP BY clause, as will be fully explained below, or a WHERE clause, as will also be fully explained below. In another embodiment of the present invention, the GUI may optionally solicit the user to select a component class selected from manager or sales. The component name is a unique name assigned to the component by the user. The component name is used by both the user and the logic residing on the application server 142 to identify the component as needed. The aggregation column specifies the sales record field on which the function is to be applied. The entries of an aggregation column must be numerical. Typically, the user will select a column containing the dollar revenue or the quantity of sales. To select an aggregation column, the GUI provides a listing of the available sales record fields to the user. The list of available sales record fields is determined at the time of deployment and is generally dictated by the structure of the tables contained in the source database 144 (see FIG. 6). Once created, the list is stored in a table in the storage database 148 (see FIG. 6). The list is provided to the GUI at the appropriate time to display to the user.

The function specifies the operation to be performed on the aggregation column. In one illustrative embodiment of the present invention, the sum function is the only choice provided to the user, i.e., the entries in the aggregation column will be summed. But, in other embodiments of the present invention, functions to find the minimum, maximum or average value of the aggregation column are provided in addition to the sum function.

Once the user has selected the aggregation column and the function, the illustrative GUI further provides a platform allowing the user to optionally create a GROUP BY clause or a WHERE clause. The function of the GROUP BY clause step is to group the sum of the aggregation column by related groups. To create a GROUP BY clause, the GUI solicits the user to select a sales record field from a second list of available fields. Like the list for the aggregation column, this second list is determined at the time of deployment from the source database 144 and the second list is also illustratively stored in a table in the storage database 148. The second list is provided to the GUI at the appropriate time to display to the user. Typically, the user will choose to group the aggregation column by the commission recipients and/or by product. The user can choose to group the sum of the aggregation column by any number of available sales record fields.

The WHERE clause further allows the user to limit or filter the sales records used by the aggregation column. The GUI illustratively solicits the user to select a sales record field from the second list. The GUI further illustratively solicits the user to select an operator, a conditional value and a connector. The operator is a conditional operand, such as equal “=”, less than “<” or greater than “>.” Other conditional operands may be specified as well. The conditional value is the value to which the entry in the sales record field is compared and the connector is “and,” “or” or “end.” One example of a WHERE clause is “Employee ID>=100 AND Employee ID<200.” The “Employee ID” is the sales record field, the operands are “>=” and “<” and the connector is “AND.” In this example, the WHERE clause would filter any sales records having an Employee ID less than 100 and greater than or equal to 200.

Once the GUI has received all of the information from a user to define a predefined function, the information is stored in the storage database 144 (see FIG. 6) in a table. Table 10, below, is a representative illustration of one form this table might take for three sample predefined functions, Revenue_Per_Rep, Transactions_Per_Rep, and Revenue_Per_Upgrade.

TABLE 10

| | | Aggregation | | |
|---|---|---|---|---|
| Component Name | Function | Column | GROUP BY | Where |
| Revenue_Per_Rep | SUM | Amount | Employee ID, | Employee ID >= 100 AND Employee ID < 200 |
| | | | Product Name | |
| Transactions_Per_Rep | SUM | Quantity | Employee ID, | Employee ID >= 100 AND Employee ID < 200 |
| | | | Product Name | AND Net > 0 and Status = Closed |
| Revenue_Per_Upgrade | SUM | Amount | Employee ID, | Work Order Type = Upgrade END |
| | | | Product Name | |

In the case of a look-up table, the GUI solicits from the user a component name, a reference component column, a list of attributes and associated values. The component name is a unique name assigned to the component by the user. The component name is used by both the user and the system to identify the look-up table as needed.

The reference component column is the sales record field that is being compared to the list of attributes in the look-up table. The GUI provides a list of all columns from an associated predefined component.

The list of attributes is what the entries in the reference component column are being compared to. In one illustrative embodiment of the present invention, the list of attributes will pre-populate once the reference component is selected. For example, if the user selects a reference component column Product_ID, then the list of attributes will automatically populate with all of the available products from the master product list, which was previously defined by the user. The user can then enter the associated values, each value being the amount awarded when there is a match with a particular entry in the reference component column and one of the entries in the list of attributes. Once the GUI has received all of the information from a user to define a look-up table, the information is stored in the storage database 144 (see FIG. 6) in a table. Table 11, below, is a representative illustration of one form this table might take for a look-up table entitled Premium_Lookup.

TABLE 11

| Component Name | Reference Column | Attribute | Value |
|---|---|---|---|
| Premium_Lookup | Product Name (from | CCH | 5.00 |
| | Transactions_Per_Rep) | HOS | 5.00 |
| | | MIT | 3.00 |

In the case of a tiered look-up table, the GUI illustratively solicits from the user a component name, a reference component column, ranges of values, the range of values comprising an attribute start and an attribute end, and an award value associated with each range. The component name is a unique name assigned to the component by the user. The component name is used by both the user and the system to identify the tiered look-up table as needed.

The reference component column is the sales record field that is being compared to the range of values. The GUI provides a list of all columns from an associated predefined component. The attribute start and attribute end define the range of values. The value is the award given when an entry in the reference component column falls in the range of values. Once completed, the tiered look-up table is stored in the storage database 148 (see FIG. 6). Table 12 below is an example of the form a tiered-look up table may take once completed.

TABLE 12

| Component | | Attribute | | |
|---|---|---|---|---|
| Name | Reference Column | Start | Attribute End | Value |
| Premium_Tier | Quantity (from | 1 | 3 | 5.00 |
| | Transactions_{—} | 3 | 5 | 12.00 |
| | Per_Rep) | 5 | 100 | 30.00 |

In will be appreciated that the parameters defining each type of component are illustratively stored in tables in the storage database 148 (see FIG. 6). This storage procedure is advantageous over the existing art in that it allows the components to be made available to a plurality of commission plans. Further, because the parameters of a component are stored in a table, they may be modified or added to at any time through the graphical user interface. It will be further appreciated that the use of the GUI to define the components advantageously removes from the user the need to know a complex programming language.

In the case of a commission plan, the GUI first solicits the user to enter or select basic plan information, including but not limited to a plan name, a plan class, an activation date, an aggregation component, the date created and the commission calculation frequency. The plan name is a unique name assigned to the commission plan by the user. The plan name is used by both the user and the system to identify the commission plan as needed. There are two types of plan classes, one determines whether the commissions are based upon individual sales, and the other determines whether the commissions are based upon the sales of others. The activation date determines when the plan will become active, thus a user is allowed to define a commission plan in advance of its use. The aggregation component is used in the commission calculation process to sum sales records according to the criterion set forth in the component definition. The date created is used for reference purposes only.

The commission calculation frequency is selected by the user and defines when the commission is to be calculated on a regular basis. A user is illustratively prompted to select weekly, bi-weekly or monthly as the commission calculation frequency. It is, however, within the scope of the present invention to have the user select any other commission calculation frequency as well. Using the commission calculation frequency and the activation date, the system is able to calculate the date ranges for which the sales records will be collected and when the commissions become owing and calculable under the plan.

Next, the GUI solicits the user to select primary recipients. The primary recipients receive the benefit of the commission plan. The GUI provides a list of available recipients which has been previously created and stored in the storage database 148 (see FIG. 6). The list may have actual names, ID numbers, or any other name convention representing an entity entitled to receive commissions. The user may also remove primary recipients if desired after the commission plan is created.

The user is also prompted to select or create a commission frequency. Typically, but not necessarily, the user selects a commission frequency of weekly, bi-weekly or monthly, but it is within the scope of the present invention to select any commission frequency that the user may desire.

The GUI also solicits the user to create a commission rule. The user is allowed to build a commission rule using components, operators, and values. The commission rule is built by creating a formula. To select a component, the user is provided a list of the names of the components that have been previously created. When a component is selected the user is in fact creating a variable and assigning that component to supply numerical values to that variable. The numerical values that are supplied to the variable are sales figures that have been extracted by the component from a table of sales records during the commission calculation process. The illustrative operators which may be utilized comprise “+”, “−”, “*” and “/” which represent addition, subtraction, multiplication and division, respectively. Also the user is permitted to enter numerical values. For example, if a component was previously created called “Total Quantity Sold by Salesperson” and it was desired to pay $50 per sale, then the commission rule would take the form “[TotalQuantitySoldbySalesPerson]*50” as viewed through the graphical user interface.

Once completed, the commission plan is stored in the storage database 148. Table 13 below is an example of the form a commission plan may take once completed and stored for three commission plans, Base_Quota_Rate, Over_Quota-Bonus, and Premium_Channel_Count.

TABLE 13

| | | Plan | Activation | Creation | Aggregation | Primary | |
|---|---|---|---|---|---|---|---|
| Commission Plan | Frequency | Class | Date | Date | Component | Recipients | Commission Rule |
| Base_Quota_Rate | Weekly | Sales | Jan. 01, 2002 | Jan. 01, 2002 | Revenue_Per_Rep | 100, 101, | Amount .06 |
| | | | | | | 102, 103 | |
| Over_Quota-Bonus | Weekly | Sales | Mar. 15, 2003 | Jan. 01, 2002 | Quota_Accelerator | 100, 101, | Value (from |
| | | | | | | 102, 103 | Quota_Accelerator) |
| Premium_Channel_Count | Weekly | Sales | Jun. 26, 2004 | Jan. 01, 2002 | Premium_Tier | 100, 101, | Value |
| | | | | | | 102, 103, | |

It will be appreciated that the parameters defining each type of commission plan are stored in a table in the storage database 148 (see FIG. 6). Storing the parameters defining each type of commission plan in a table in the storage database 148 is advantageous over the existing art in that it allows the commission plan to be made available when called. Further, because the parameters of a commission plan are stored in a table, they may be modified or added to at any time through the GUI. It will be further appreciated that the use of the GUI to define the components advantageously removes from the user the need to know a complex programming language.

In one illustrative embodiment of the present invention, the GUI also provides the user the option to manage the commission plans after they have been created. In particular, the user may select a commission plan to be retired or deleted. Retiring a commission plan preferably marks the commission plan as not to be used in the commission calculation process but does not delete it from the storage database 148 (see FIG. 6). Thus, a retired commission plan can be reviewed or used as a basis to create a new plan. Deleting a commission plan preferably removes the commission plan from the storage database 148.

In another illustrative embodiment of the present invention, the GUI solicits the user to define an organizational hierarchy and the appropriate commission distribution. In addition, the user is optionally allowed to restrict access through the client by assigning a login and password. The organizational hierarchy allows the user to define a hierarchal relationship between commission recipients, such as employees. It should be noted that the user can define any other type of hierarchal relationship in addition to that of employees. The GUI illustratively solicits the user to define user types. A user type groups recipients into classes to allow for the creation of an organizational hierarchy. After the user types have been entered, the user is allowed to enter pertinent information relating to the recipients including, without limitation, the recipients name, title, user type, sales rep id, supervisor name, department or group. The GUI displays all recipients and their pertinent information in a list format. The user is allowed to add, delete or modify from this list. Once the organizational hierarchy has been created then the information is saved in a table on the storage database 148 (see FIG. 6).

Once the user has entered all required information to define the criteria under which the commissions will be calculated pursuant to the particular embodiment of the invention that is being implemented, the user can trigger the application server 142 (see FIG. 6) to begin the calculation process. The GUI illustratively solicits from the user to select the specific instance for which the commissions will be calculated as determined by the commission policy. Once the user has selected the specific instance, the GUI displays all commission plans by name that have commissions owing and calculable for that specific instance. In one illustrative embodiment of the present invention, the user clicks a “Load Plan” button to display the commission plans that will be calculated for that specific instance. Clicking the “Load Plan” button triggers the application server 142 to retrieve the commission plans from the storage database 148 (see FIG. 6). The application server 142, database management system 146 and storage database 148 are one example of a selecting means for selecting commission plans having commissions owing and calculable. It will be appreciated that the selecting means disclosed herein is merely one example of accomplishing the selection of the commission plans, other suitable arrangements known or readily ascertainable, to those skilled in the art, may be used and are within the scope of the present invention.

In addition, once the user has selected the specific instance the application server 148 also imports the applicable sales records for each of the commission plans from the source database 140 into the storage database 148. The application server 142 is one example of an importing means for importing sales records from a source database 144. It will be appreciated that the importing means disclosed herein is merely one example of accomplishing the importing of sales records from a source database 144, other suitable arrangements known or readily ascertainable, to those skilled in the art, may be used and are within the scope of the present invention.

The source database 144 is any database containing valid sales records upon which commissions are to be based. Typically, the source database 144 will comprise database tables populated with the sales records. The sales records are preferably, but not necessarily, updated on a continual basis. The database tables in the source database 144 will have unique column names, a different number of columns, and unique data values for each user. Typically, at a minimum, each sales record must have a date by which the commission will be realized. This date may be a transaction date, an order date, a billing date or any other date. The source database 144 may be part of an independent system 145 such as a billing system or an order entry system. Using a billing system as the source data is usually preferable over an order entry system, but those skilled in the art can best select where the source data originates in accordance with the information set forth herein.

In order to import the applicable sales records for each of the commission plans, the application server 142 (see FIG. 6) creates a query using a structured query language, such as SQL (as described earlier), to import the records from the source database 144. The query is directed to the source database 144, and in particular, the database management system of the source database 144, to retrieve sales records spanning a date range. The query is composed using the commission frequency of each commission plan which identifies the date range for which the query spans. For example, if the commission frequency of a particular plan is weekly, then the query as created by the application server 142 will import all sales records for that week corresponding to the specific instance. If the commission frequency of a particular plan is monthly, then the query as created by the application server 142 will import all sales records for that month corresponding to the specific instance. The application server 148 can import the sales records automatically once the commission plans have been loaded or the user can click a button, such as a “Load Data” button to trigger the event. Once imported, the applicable sales records are stored in an import table in the storage database 148. It should be noted that the import table retains the same attributes as contained in the source database 144. An example of an import table is illustrated in Table 14. The examples provided in Table 14 are merely illustrative and are not intended to be limiting of the scope of the present invention.

TABLE 14

| | Employee | Work Order | | | | | | Customer | |
|---|---|---|---|---|---|---|---|---|---|
| Date | ID | Type | Product Code | Option Flag | Quantity | Amount | Net | Name | Status |
| Jan. 6, 03 | 102 | New Connect | BASIC, CCH | HBW | 1 | 39.99 | 2 | John Smith | Closed |
| Jan. 6, 03 | 102 | Upgrade | CCH | | 1 | 9.99 | 1 | □ | Closed |
| Jan. 6, 03 | 103 | New Connect | BASIC, PREM | CCH, HOS, | 1 | 39.99 | 2 | A Sports Bar | Closed |
| | | | | MIT | | | | | |
| Jan. 6, 03 | 104 | New Connect | BASIC | T2 | 1 | 21.99 | 1 | □ | Closed |
| Jan. 7, 03 | 105 | Reconnect | BASIC | T3 | 1 | 45.99 | 0 | □ | Pending |
| Jan. 10, 03 | 105 | New Connect | BASIC | T2 | 1 | 21.99 | 1 | □ | Open |
| Jan. 15, 03 | 105 | Upgrade | PREM | CCH HOS | 3 | 35.99 | 0 | □ | Closed |
| | | | | MIT | | | | | |
| Jan. 6, 03 | 202 | Trouble Call | BASIC | T3 | 1 | 45.99 | 1 | □ | Closed |
| Jan. 05, 03 | 202 | Bury Drop | AO | | 3 | 30.00 | 0 | □ | Open |
| Jan. 05, 03 | 204 | Trouble Call | MODEM | 512K | 2 | 200.00 | 1 | □ | Closed |
| Jan. 16, 03 | 204 | Trouble Call | CCH | HBW | 1 | 39.99 | 1 | □ | Closed |

Once the sales records for the specific instance selected by the user have been imported into an import table, the application server 142 (see FIG. 6) can then apply each of the applicable commission plans to determine the commissions. The application server 142 can automatically be triggered to calculate the commissions or the user can trigger the calculation process by taking action, such as clicking a button on the graphical user interface, for example a “Calculate Commissions” button.

The application server 142 calculates the commissions owing and calculable for each commission plan one plan at a time. Once a commission plan has been selected by the application server 142 (see FIG. 6), the first step is to identify all of the primary recipients for that commission plan from the commission plan parameters stored in the storage database 148.

In accordance with one illustrative embodiment of the present invention, for every primary recipient a worksheet is created if one does not already exist. In accordance the illustrative embodiment of the present invention, a worksheet is a table containing all of the commissions earned by a recipient for a specific instance. Once the worksheet has been created, then, for each primary recipient, the component is applied to the import table to extract the sales figures and the results are saved in a row in the calculated component table. The application server 142, database management system 146 and storage database 148 are one example of an extraction means for applying a component to sales records to extract sales figures. It will be appreciated that the extraction means disclosed herein is merely one example of accomplishing the extraction of the sales figures, other suitable arrangements known or readily ascertainable, to those skilled in the art, may be used and are within the scope of the present invention.

Lastly, the commission rule is applied, i.e., the commission rule is solved, to the row in the calculated component table for the primary recipient and the results are sent to the worksheet for that primary recipient. The above-recited steps are repeated for each primary recipient. These steps will be explained in more detail below. The application server 142, database management system 146 and storage database 148 are one example of a calculation means for solving a commission rule. It will be appreciated that the calculation means disclosed herein is merely one example of accomplishing the solving of the commission rule, other suitable arrangements known or readily ascertainable, to those skilled in the art, may be used and are within the scope of the present invention.

As explained above, for each primary recipient, the component is applied to the import table. The manner in which the component for each primary recipient is applied is determined by whether the component is a predefined function, a look-up table or a tiered look-up table.

In the case of a predefined function, the application server 142 (see FIG. 6) combines the aggregation column, function, GROUP BY clause and WHERE clause into one query which is sent to the database management system (DBMS), represented at 146 in FIG. 6, to apply to the import table stored in the storage database 148. In addition, prior to creating the query, whatever the WHERE clause is, the application server 142 appends to the WHERE clause conditions to filter any sales records falling outside the particular date range being calculated and to filter any records from sales personnel other than the primary recipient. This modification of the WHERE clause ensures that the sales records are appropriate for the date range determined by the commission plan and for the primary recipient.

Alternatively and illustratively, in the case of a predefined function used in a plan class where the commission plan is flagged to indicate that the commissions of the primary recipient are based upon the sales of others, i.e., subordinates, then the WHERE clause is appended to filter any records not belonging to the subordinates. The subordinates for each primary recipient can be determined from the organizational hierarchy or in accordance with techniques which those skilled in the art can derive using the information provided herein. The application server 142, database management system 146 and storage database 148 are one example of a determining means for determining the subordinates from a hierarchal list. It will be appreciated that the determining means disclosed herein is merely one example of accomplishing the determination of subordinates, other suitable arrangements known or readily ascertainable, to those skilled in the art, may be used and are within the scope of the present invention.

Once the query has been created in accordance with the exemplary procedure set forth in the proceeding paragraphs, it is executed on the import table and the output is stored in a row of the calculated component table. In this case, the output comprises sales figures and any sales record fields named in the GROUP BY column. As used herein, the term “sales figures” refers to any numerical amount obtained by, for example, a component from the input table upon which a commission can be calculated, as well as structures and procedures providing the same or equivalent results.

It will be appreciated that because the above noted modifications to the WHERE clause at run time, the output from applying the component to the import table relates only to one of the primary recipients. Thus, in this illustrative embodiment of the present invention, the component is applied to the import table for each of the primary recipients in the selected commission plan. This modification of the WHERE clause is advantageous because it allows the component to be applied for each primary recipient without requiring the user to create a component for each primary recipient.

In the case where the component is a look-up table or a tiered look-up table, the exemplary first step is to apply the predefined function serving as the source to the look-up or tiered look-up table. The predefined component is determined from the reference component column selected during the creation of the look-up table or tiered look-up table. The step of applying the predefined function used as the source of look-up or tiered look-up table involves the same, or similar, procedures as described above in the case of the predefined function and the results are stored in the calculated component table. The look-up table or tiered look-up table is not used to create the calculated component table, but rather only the predefined function named as the source for either table. The actual look-up or tiered look-up table is used when applying the commission rule as will be described below.

Once the row found by the predefined function has been entered into the calculated component table, the application server 142 then applies the commission rule of the commission plan for which the commissions are being calculated to that row. The commission rule is obtained from the table containing the parameters of the commission plan. In order to apply the commission rule, the application server 142 (see FIG. 6) builds an arithmetic expression for the row based upon the composition of the commission rule.

It will be noted that because the calculated component table has a row for each primary recipient, that the commission rule will be applied for each primary recipient because it is applied to each row. Further, it should be understood that applying the commission rule can comprise multiple applications of the commission rule, i.e., once for each row in the calculated component table.

The application server 142 parses the commission rule from left to right to build the arithmetic expression for the row. When a component is identified in the commission rule, the application server 142 applies a different procedure depending on the type of component. In the case of a predefined function, the procedure obtains the ID of the aggregation column for the predefined function and gets the value in the corresponding column of the row. This value is then appended to the arithmetic expression.

In the case of a look-up table, the illustrative procedure obtains the ID of the referenced component column and gets the value in the corresponding column of the row. The value is then matched in the look-up table to find the award value. This award value is appended to the arithmetic expression.

In the case of a tiered look-up table, the illustrative procedure obtains the ID of the referenced component column and gets the value in the corresponding column of the row in the calculated component table. The value is then compared with the ranges in the tiered look-up table to find the appropriate award value. This award value is then appended to the arithmetic expression.

When a numerical value or an operator is identified in the commission rule, the application server 142 appends the numerical value or operator to the arithmetic expression.

Once the commission rule is completely parsed, the arithmetic expression is ready to be solved. Once the arithmetic expression is solved, the results can be stored in the worksheet of the primary recipient to which the row pertains. The above described procedure is repeated for each row on the calculated component table. Once all of the rows in the calculated component table have been subjected to the commission rule, then the entire process can be repeated for any remaining commission plans. Table 15, provided below, is an example of a worksheet for a primary recipient based upon three commission plans. The examples provided in Table 15 are merely illustrative and are not intended to be limiting of the scope of the present invention.

TABLE 15

| Commission Plan | Amount | Quantity | Commission |
|---|---|---|---|
| Base_Quota_Rate | $299.85 | □ | $17.99 |
| Over_Quota_Bonus | $299.85 | □ | $100.00 |
| Premium_Channel_Count | □ | 5 | $30.00 |
| Total Commission | □ | □ | $147.99 |

Once all of the commission plans for a specific instance have been calculated, the commissions can be calculated for another specific instance and the entire process is repeated. Moreover, the calculated commissions can be outputted to a display or printer. The application server 142 and client 138 is one example of an outputting means for displaying the calculated commissions. It will be appreciated that the outputting means disclosed herein is merely one example of accomplishing the display of the commissions, other suitable arrangements known or readily ascertainable, to those skilled in the art, may be used and are within the scope of the present invention.

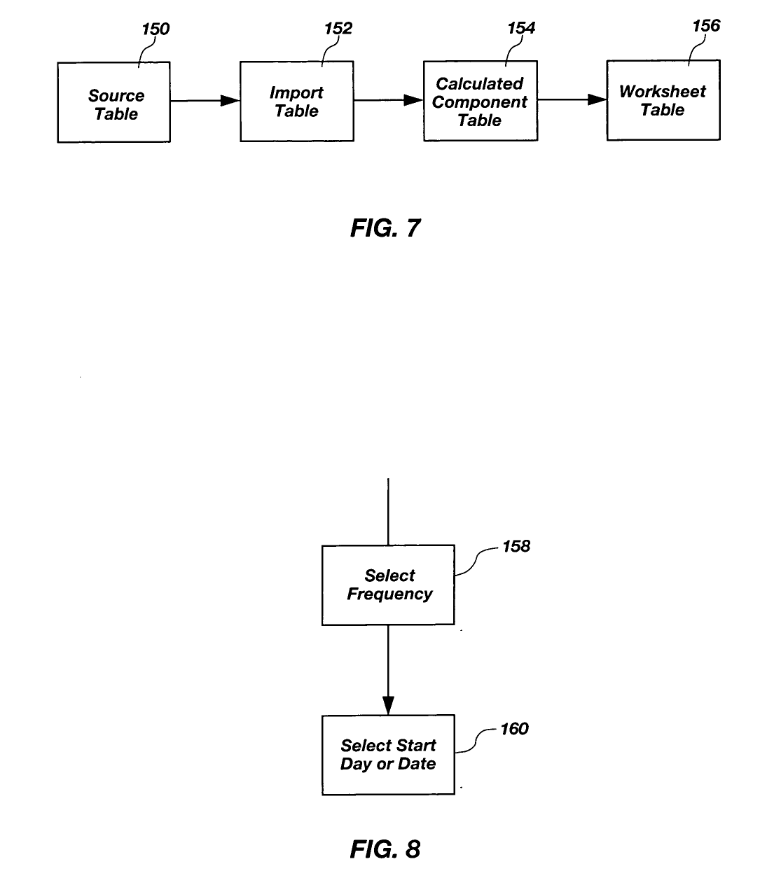

In the above-described manner, the commissions can be calculated on a reoccurring basis. FIG. 7 illustrates the data flow from table to table until the final commissions are calculated. A source table 150, typically residing in the source database 144, shown in FIG. 6, contains a plurality of sales records. The source table 150 is typically continuously updated with new records. A portion of the sales records is then imported into an import table 152. The sales records in the import table 152 are the sales records for which commissions are owing and calculable. The import table 152 then has a component applied to it to create a calculated component table 154. The calculated component table 154 is generally created by applying a query defined by the component to the import table 152. The commission rule is then applied to the calculated component table 154 and the results are stored in a worksheet table 156. It should be noted that the data can transferred from table to table one row at a time or any number of rows at a time or in any suitable manner that is known to one skilled in the art.

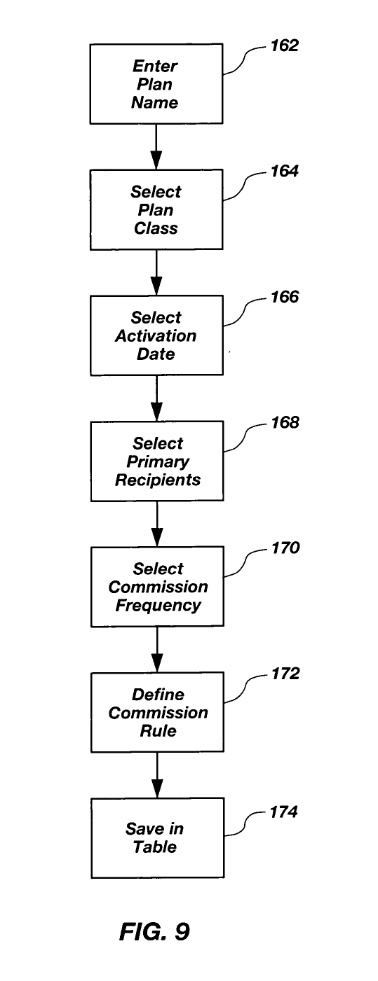

Reference will now be made to the exemplary flow diagram of FIG. 8. In one illustrative embodiment of the present invention the user is prompted to define a commission policy by selecting a frequency (step 158) and then select a start day or date (step 160). Reference will now be made to the flow diagram of FIG. 9. In one illustrative embodiment of the present invention in order to define a commission plan, the user is prompted to enter a plan name (step 162) and select a plan class (step 164), an activation date (step 166), the primary recipients (step 168), and the commission plan frequency (step 170). The user is further solicited to define the commission rule (step 172). Once this information has been received, the information obtained from the user is saved in a table (step 174).

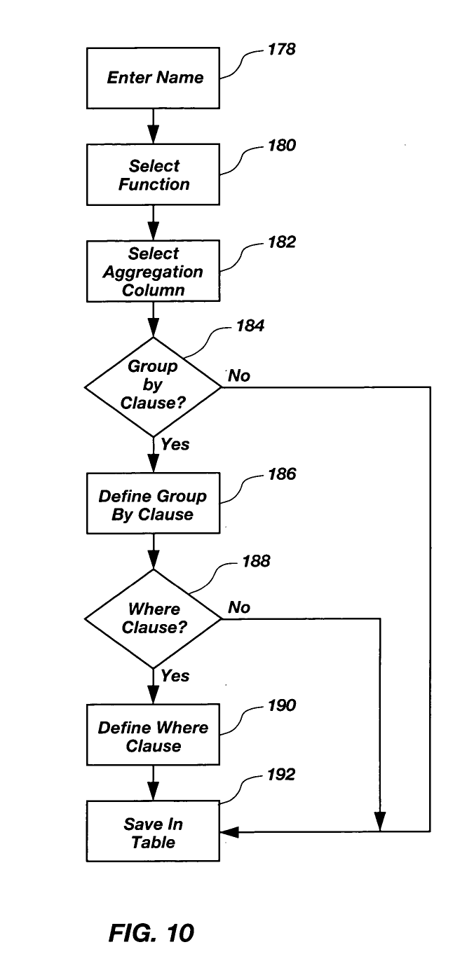

Reference will now be made to the exemplary flow diagram of FIG. 10. In one illustrative embodiment of the present invention in order to define a component, the user is prompted to enter a component name (step 178) and select the function (step 180) and the aggregation column (step 184). The user is then solicited to define a GROUP BY clause (step 184), if not, then the information is saved in a table (step 192), if the user does want to define a GROUP BY clause, then the user defines the clause (step 186). The user is then solicited to define a WHERE clause (step 188), if no, then the current information is saved in a table (step 192), if yes, then the user defines the WHERE clause (step 190). Once completed, the information defining the component is saved in a table (step 192) for use at a later time.

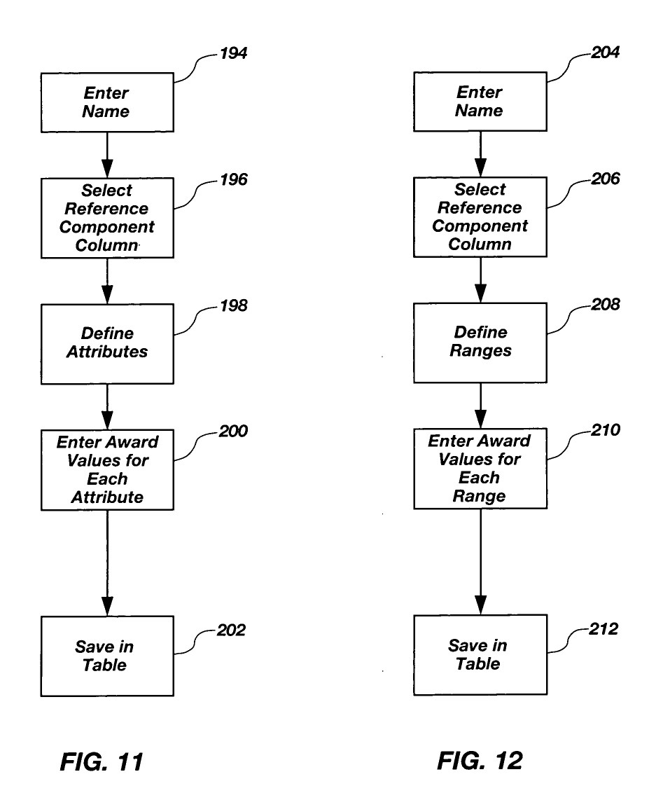

Reference will now be made to the exemplary flow diagram of FIG. 11. In one illustrative embodiment of the present invention in order to define a look-up table, the user is prompted to enter a name (step 194) and select a reference component column (step 196) and define the attributes (step 198) and the award values associated with each attribute (step 200). Once completed the information is saved in a table (step 202) for use at a later time.

Reference will now be made to the exemplary flow diagram of FIG. 12. In one illustrative embodiment of the present invention in order to define a tiered look-up table, the user is prompted to enter a name (step 204) and select a reference component column (step 206) and define the range of values (step 208) and the award values associated with each range of values (step 210). Once completed, the information is saved in a table (step 212) for use at a later time.

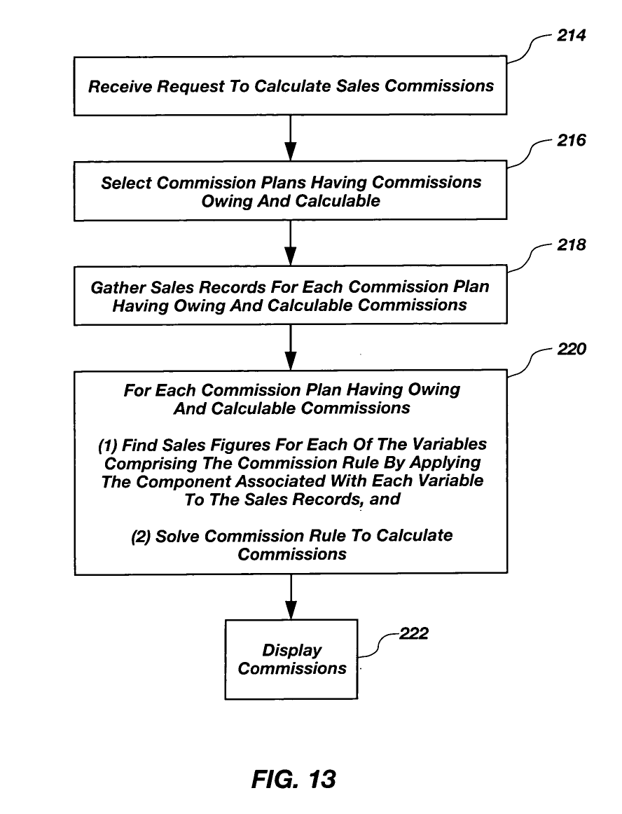

Reference will now be made to the exemplary flow diagram of FIG. 13. In one illustrative embodiment of the present invention there is represented a method to calculate commissions. The first step is to receive a request to calculate commissions (step 214). The commission plans having commissions owing and calculable are then selected (step 218) and sales records for those plans are gathered (step 218). For each of the commission plans having commissions owing and calculable, the component associated with the commission rule of each of the plans is applied to the sales records and the commission rule is solved (step 220). The commissions are then outputted (step 222).

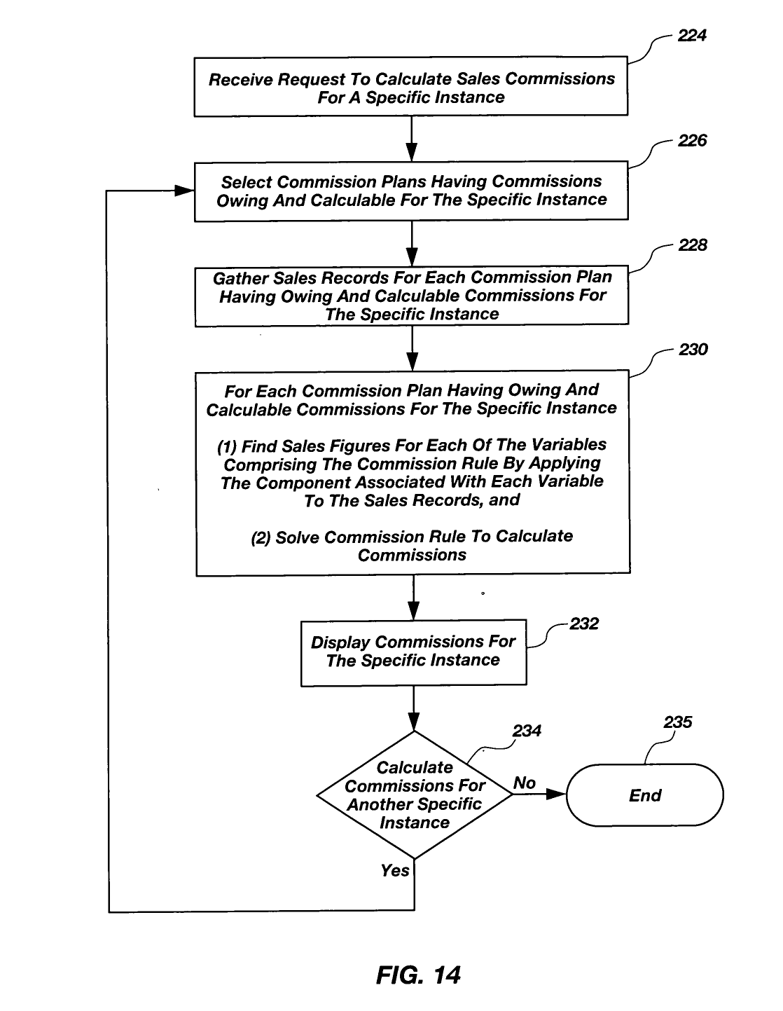

Reference will now be made to the exemplary flow diagram of FIG. 14, in another embodiment of the present invention, there is represented an illustrative method to calculate commissions. The first step is to receive a request to calculate commissions for a specific instance (step 224). The commission plans having commissions owing and calculable for the specific instance are then selected (step 226) and sales records for those plans are gathered (step 228). For each of the commission plans having commissions owing and calculable for the specific instance, the component associated with the commission rule of each of the plans is applied to the sales records to extract sales figures. The sales figures are provided to the commission rule, and the commission rule is solved (step 230) to calculate the commissions. The commissions are then outputted (step 232). Finally, if desired, the commissions can be calculated for another specific instance (step 234) or the method ended (step 235).

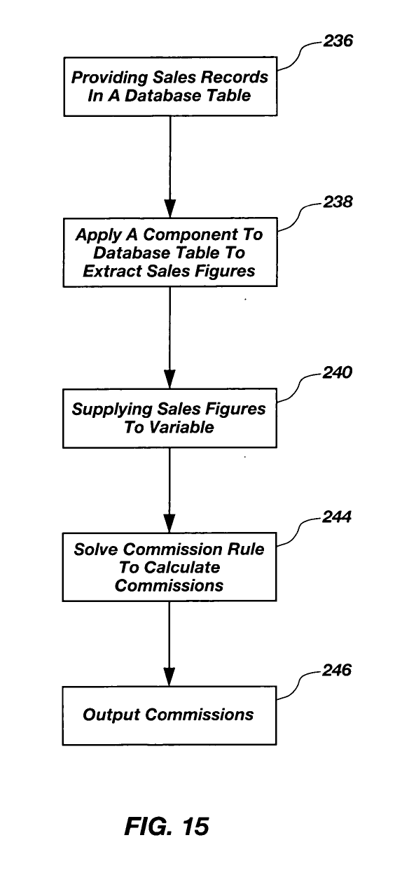

Reference will now be made to the exemplary flow diagram of FIG. 15. In one illustrative embodiment of the present invention there is represented an illustrative method to calculate commissions. The first step is to provide sales records in a database table (step 236). A component is then applied to the database table to extract sales figures (step 238). The sales figures are then supplied to a variable (step 240) and the commission rule is solved to calculate the commissions (step 244). The commissions are then outputted (step 246) as necessary.

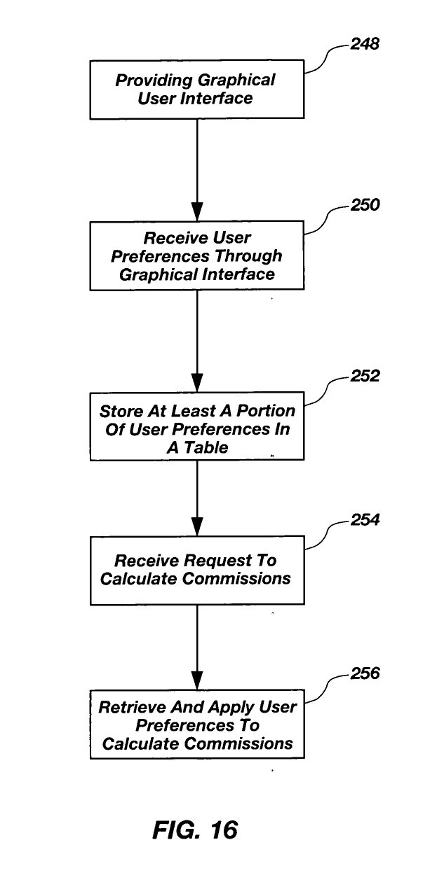

Reference will now be made to the exemplary flow diagram of FIG. 16. In one illustrative embodiment of the present invention there is represented an illustrative method to calculate commissions. The first step is to provide a graphical user interface to receive the user preferences (step 248) and to receive the user preferences (step 250). A portion of the preferences is saved in a table (step 252) for later use. When a request to calculate commissions is received (step 254) the preferences saved in the table are retrieved and applied to calculate the commissions (step 256).

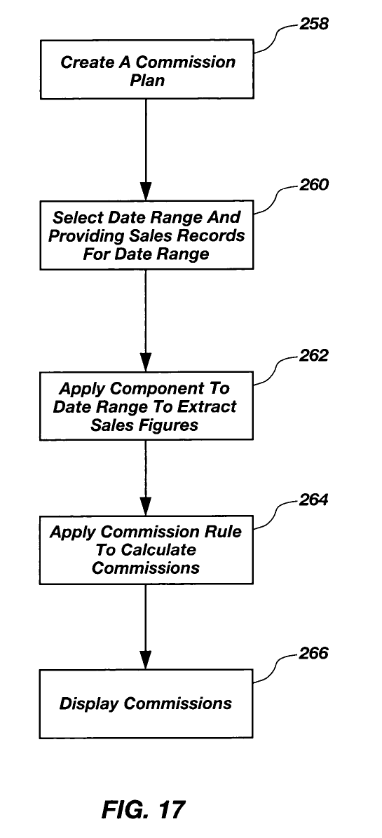

Reference will now be made to the exemplary flow diagram of FIG. 17. In one illustrative embodiment of the present invention there is represented a method to calculate commissions. The first step is to create a commission plan (step 258) and select a date range for which the commission plan has commissions owing and calculable (step 260), and collect sales records for that date range (step 260). The next step is to apply the component to the date range to extract sales figures (step 262). Once the sales figures have been extracted, the commission rule is applied to calculate commissions (step 264). The commissions are then outputted (step 266).

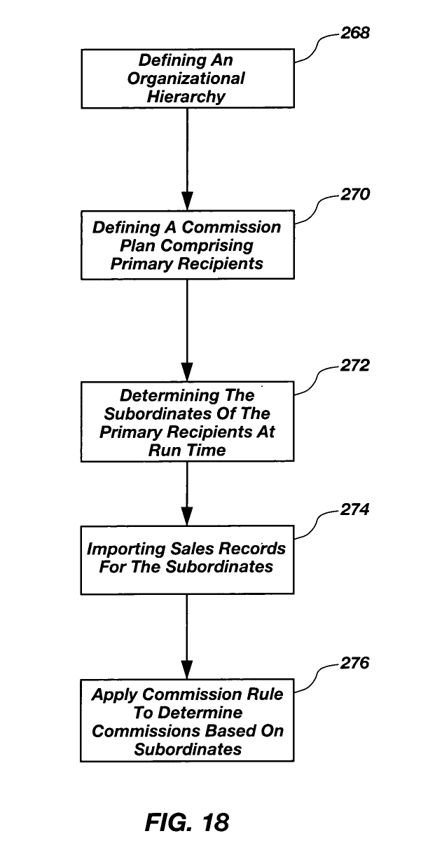

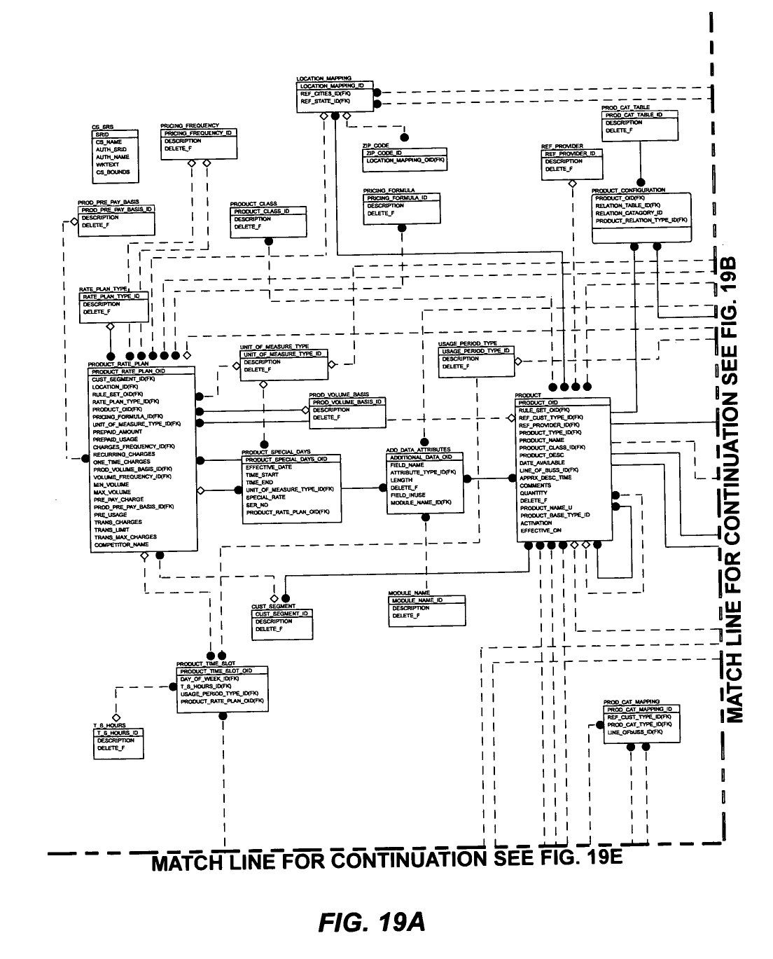

Reference will now be made to the exemplary flow diagram of FIG. 18. In one illustrative embodiment of the present invention there is represented a method to calculate commissions. The first step is to define an organizational hierarchy (step 268) and a commission plan having primary recipients (step 270) earning commissions based upon the sales of subordinates (step 272). At run time, the subordinates of the primary recipients are determined from the organizational hierarchy (step 272) and sales records for the subordinates are imported (step 274). A commission rule is applied to the sales records to determine the commissions of the primary recipients based upon the sales of the subordinates (step 276).

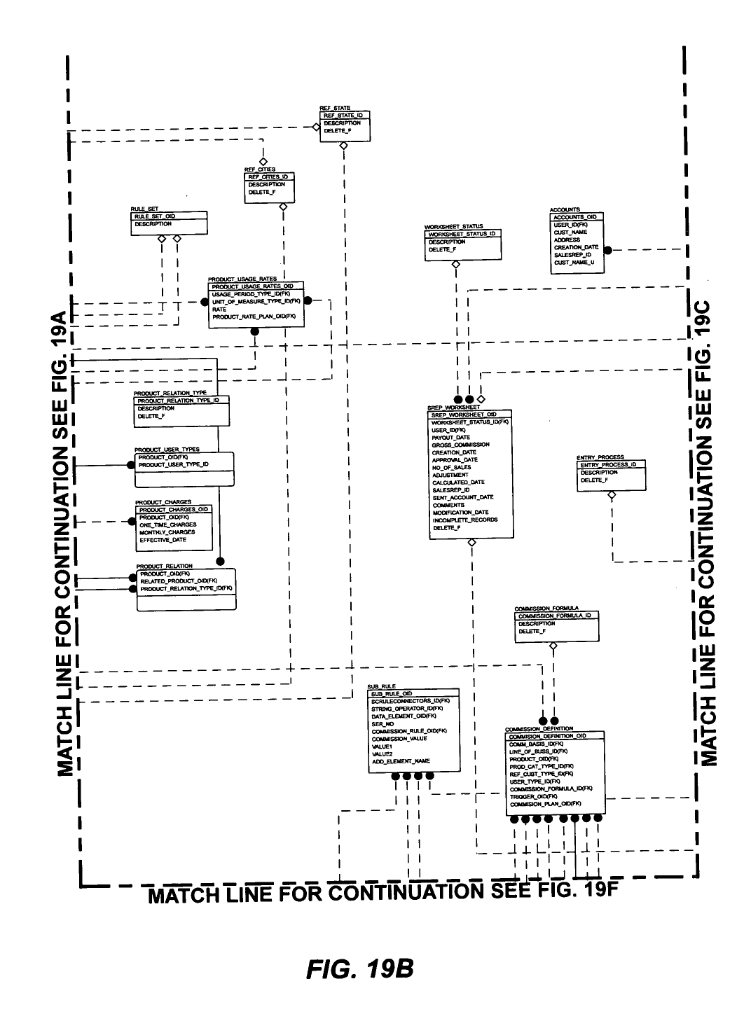

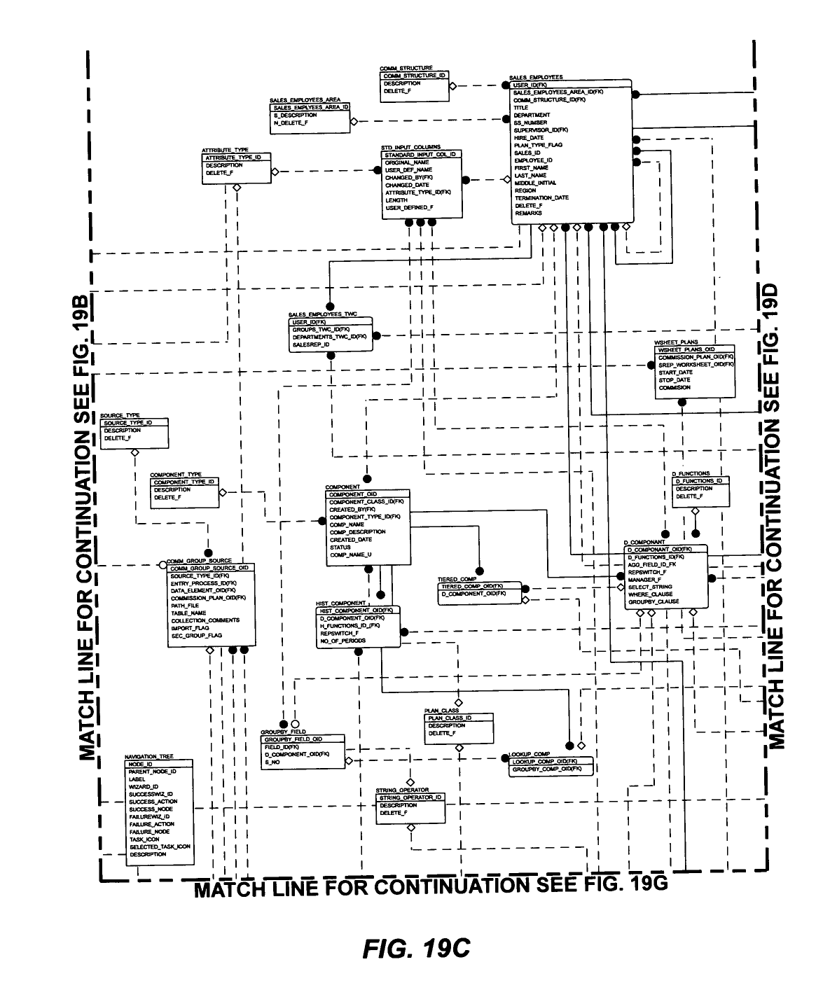

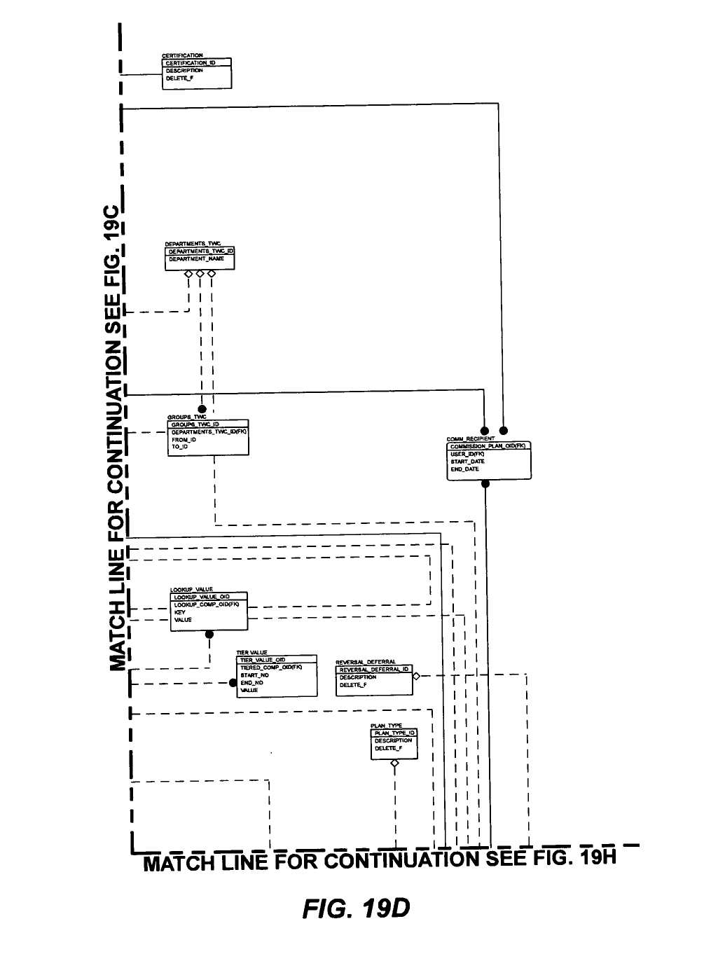

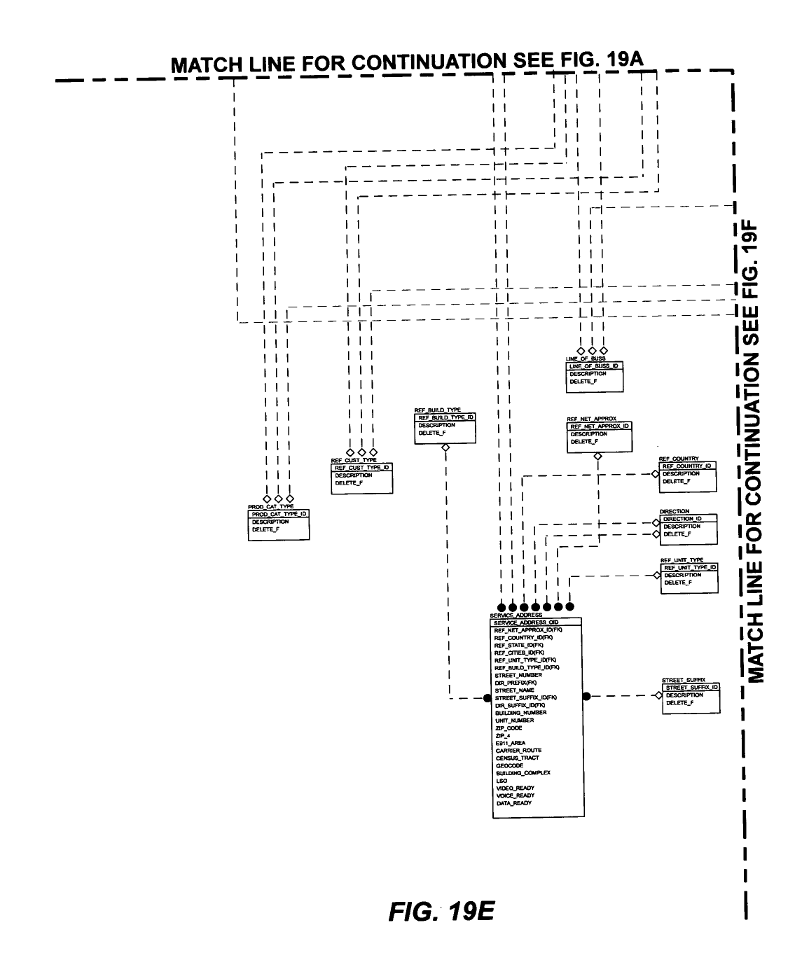

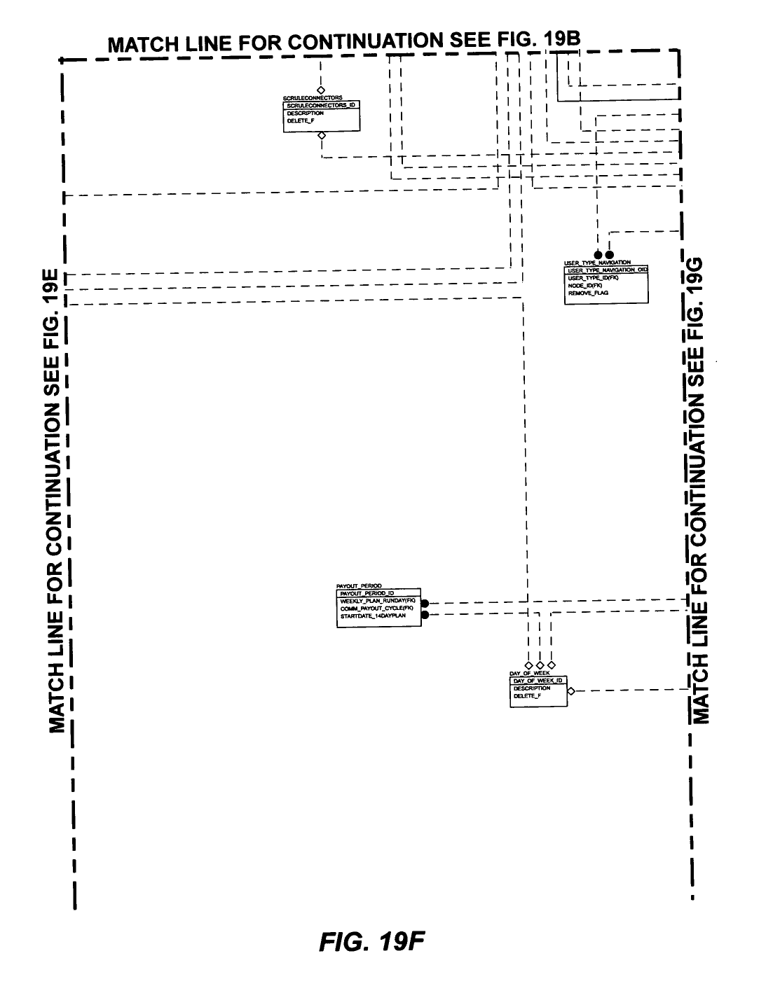

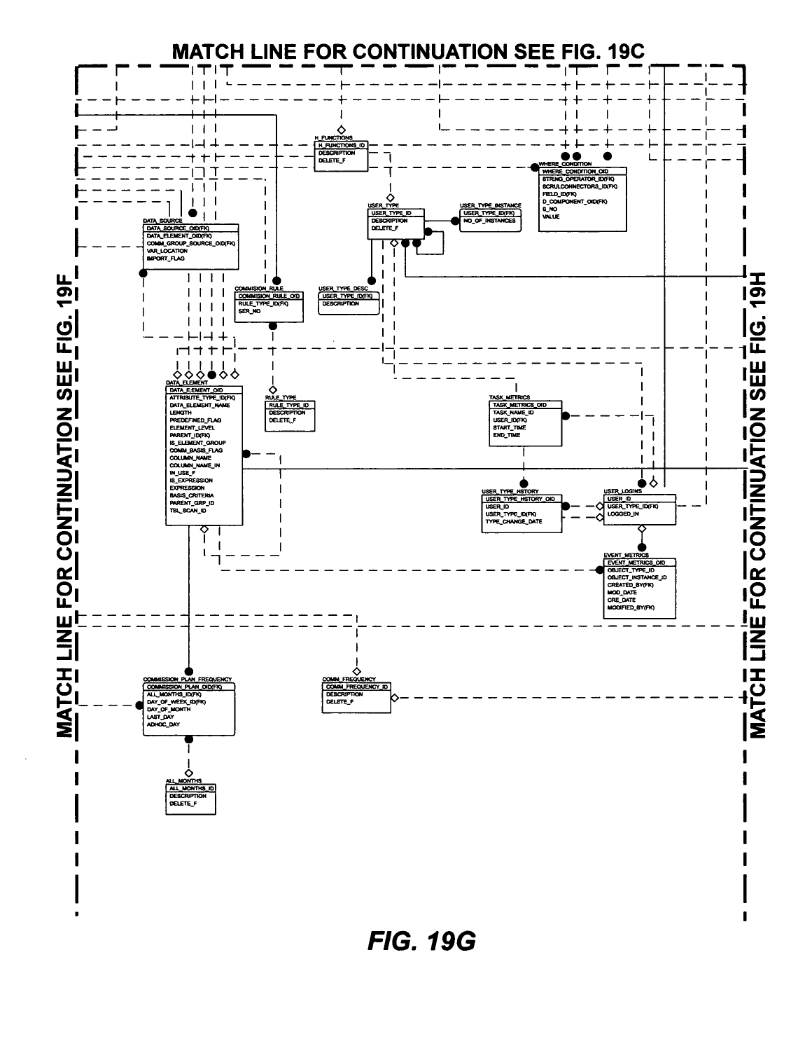

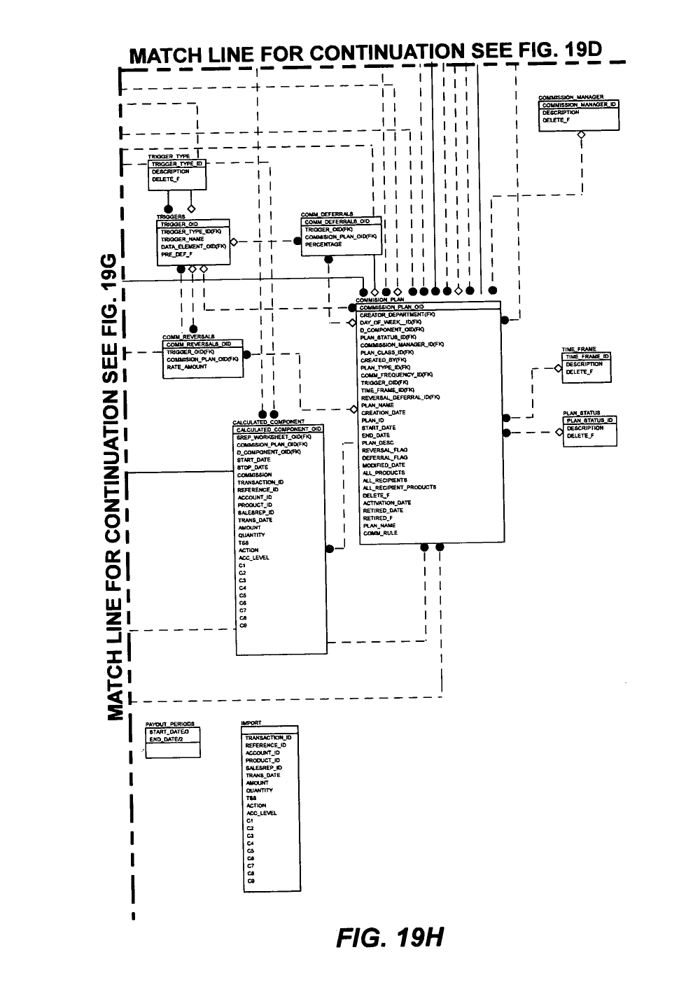

Referring now to FIGS. 19A-19H, there is represented an illustrative architecture for one illustrative embodiment of the present invention. A legend for the labels and a short description of each of the labels shown in FIGS. 19A-19H, is provided in Table 16 below. It is to be understood that the illustrative architecture represented in FIGS. 19A-19H is merely exemplary of many different structures and methods which can be used to carry out the present invention and the structures and methods represented in FIGS. 19A-19H is not intended to be limiting of the scope of the present invention.

TABLE 16

| Label | Description |
|---|---|
| ACCOUNTS | |
| ADD_DATA_ATTRIBUTES | |
| ALL_MONTHS | |
| ATTRIBUTE_TYPE | |
| CALCULATED_COMPONENT | |
| CERTIFICATION | |
| COMM_DEFERRALS | |
| COMM_DEFINITION_RULES | |
| COMM_FREQUENCY | |
| COMM_GROUP_SOURCE | |
| COMM_RECIPIENT | |
| COMM_RECIPIENT_SREP | |
| COMM_RECIPIENT_STYP | |
| COMM_REVERSALS | |
| COMM_STRUCTURE | |
| COMMISSION_DEFINITION | |
| COMMISSION_FORMULA | |
| COMMISSION_MANAGER | |
| COMMISSION_PLAN | |
| COMMISSION_PLAN_FREQUENCY | |
| COMMISSION_RULE | |
| COMPONENT | |
| COMPONENT_PRODUCT | |
| COMPONENT_TYPE | |
| CS_SRS | |
| CUST_SEGMENT | |
| D_COMPONENT | |
| D_FUNCTIONS | |
| DATA_ELEMENT | |
| DATA_ELEMENT | |
| DATA_SOURCE | |
| DAY_OF_WEEK | |
| DEPARTMENTS_TWC | |
| DIRECTION | |
| EMPLOYEE_SUBORDINATES | |
| EMPLOYEE_SUPERVISORS | |
| ENTRY_PROCESS | |
| EVENT_METRICS | |
| GEODETRIC_SRIDS | |
| GROUPBY_FIELD | |
| GROUPS_TWC | |
| H_FUNCTIONS | |
| HIST_COMPONENT | |
| IMPORT | |
| LINE_OF_BUSS | |
| LOCATION_MAPPING | |
| LOOKUP_COMP | |
| LOOKUP_VALUE | |
| MODULE_NAME | |
| NAGIVATION_TREE | |
| PAYOUT_PERIOD | |
| PAYOUT_PERIODS | |
| PLAN_CLASS | |
| PLAN_STATUS | |
| PLAN_TYPE | |
| PRICING_FORMULA | |
| PRICING_FREQUENCY | |
| PROD_CAT_MAPPING | |
| PROD_CAT_TABLE | |
| PROD_CAT_TYPE | |
| PROD_PRE_PAY_BASIS | |
| PROD_VOLUME_BASIS | |
| PRODUCT | |
| PRODUCT_CHARGES | |
| PRODUCT_CLASS | |
| PRODUCT_CONFIG_VARIABLES | |
| PRODUCT_CONFIGURATION | |
| PRODUCT_CUST_SEGMENTS | |
| PRODUCT_LOCATIONS | |
| PRODUCT_RATE_PLAN | |
| PRODUCT_RELATION | |
| PRODUCT_RELATION_TYPE | |
| PRODUCT_SPECIAL_DAYS | |
| PRODUCT_TIME_SLOT | |
| PRODUCT_USAGE_RATES | |
| PRODUCT_USER_TYPES | |
| RATE_PLAN_TYPE | |
| REF_BUILD_TYPE | |
| REF_CITIES | |
| REF_COUNTRY | |
| REF_CUST_TYPE | |
| REF_NET_APPROX | |
| REF_PROVIDER | |
| REF_STATE | |
| REF_UNIT_TYPE | |
| REVERSAL_DEFERRAL | |
| RP_PRICING_VARIABLES | |
| RULE_SET | |
| RULE_TYPE | |
| SALES_EMPLOYEES | |
| SALES_EMPLOYEES_AREA | |
| SALES_EMPLOYEES_CERTIFICATION | |
| SALES_EMPLOYEES_TWC | |
| SCRULECONNECTORS | |
| SERVICE_ADDRESS | |
| SOURCE_TYPE | |
| SREP_WORKSHEET | |
| STD_INPUT_COLUMNS | |
| STREET_SUFFIX | |
| STRING_OPERATOR | |
| SUB_RULE | |
| T_S_HOURS | |
| TASK_METRICS | |
| TIER_VALUE | |
| TIERED_COMP | |
| TIME_FRAME | |
| TRIGGER_TYPE | |
| TRIGGERS | |
| UNIT_OF_MEASURE_TYPE | |
| USAGE_PERIOD_TYPE | |
| USER_LOGINS | |
| USER_TYPE | |
| USER_TYPE_DESC | |
| USER_TYPE_HSTRY | |
| USER_TYPE_INSTANCE | |
| USER_TYPE_NAVIGATION | |
| USER_TYPE_REL | |
| VUE_LOCATIONS | |
| VW_BIWEEKLY_COMM | |
| VW_NPREM_COMM | |
| VW_PREM_COMM | |
| VW_SALES_EMPLOYEES | |
| VW_SALES_EMPLOYEES | |
| VW_TWC_PERIOD_IMPORT | |
| VW_TWC_QTY_CANCEL | |
| VW_TWC_QTY_INSTALL | |
| VW_TWC_QTY_JOIN_CANCEL | |
| VW_TWC_QTY_JOIN_INSTALL | |
| VW_TWC_WKLY_CANCEL | |
| VW_TWC_WKLY_INSTALL | |
| VW_TWC_WKLY_JOIN_CANCEL | |
| VW_TWC_WKLY_JOIN_INSTALL | |
| VW_TWC_YTD_PROD_IMPORT | |
| VW_WKLY_PROD_IMPORT | |
| VW_YTD_NPREM_COMM | |
| WHERE_CONDITION | |
| WORKSHEET_STATUS | |
| WSHEET_PLANS | |
| ZIP_CODE | |

Additionally, Table 17 below contains a glossary of the key terms used in this application. The glossary is provided to briefly describe some of the key terms to assist the reader in understanding the present invention, and therefore should not be construed as limiting the scope of the present invention in anyway.

TABLE 17

| | |
|---|---|
| Commission Plan | The terms and conditions under which the |
| | commissions will be paid. A commission plan can |
| | comprise a list of primary recipients, a commission |
| | rule, and a commission calculation frequency. |
| Commission Rule | Defines the rules of how the commissions will be |
| | calculated. A commission rule typically comprises a |
| | variable receiving sales figures extracted by a |
| | component and mathematical operands. |
| Commission Policy | Defines the specific instances by which |
| | commissions are calculated. |
| Component | Components are used to extract sales figures from |
| | sales records typically imported from an external |
| | source and may comprise a predefined function, a |
| | look-up table or a tiered look-up table. Components |
| | supply the sales figures to variables contained in the |
| | commission rules. |
| Look-up Table | A type of component comprising a list of attributes, |
| | each attribute having a corresponding award value. |
| Master Product List | A list of products defined by a user. The master |
| | product list can be used to validate the completeness |
| | of sales records and also identify products based |
| | upon cryptic codes used in the sales records. |
| Predefined Function | A type of component defining a query to be applied |
| | to the sales records, also known as a domain |
| | modeler element. |
| Primary Recipients | Recipients of the commissions under a commission |
| | plan. |
| Tiered Look-up | A type of component comprising ranges of values |
| Table | and associated award amounts. |

As can be observed from the illustrative embodiments described above, the present invention provides an automated process from start to finish to calculate commissions. First, the sales records are imported from an external source, such as an order entry system or a billing system. Next, sales figures are extracted from the sales records. Third, from the sales figures, the commissions are calculated. Finally, the calculated commissions are stored and/or outputted as needed. Thus, the present invention has automated what was previously done in several piecemeal steps. Furthermore, the above process can be repeated for any number of instances as defined by the user. Moreover, the preferred embodiment of the present invention provides a graphical user interface thereby allowing an relatively unsophisticated user to create and define an extremely complex commission structure with minimal effort and time.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed:

1. A method of calculating commissions based upon a plurality of commission plans, each of the plurality of commission plans comprising a commission rule, said commission rule comprising one or more variables, each variable having a component as a data source, said method comprising steps of:
receiving a request to calculate commissions;
selecting at least one commission plan from the plurality of commission plans, each of the at least one commission plan having commissions owing and calculable for a particular date range;
gathering sales records, each sales record comprised of a transaction date falling in the particular date range of one of the at least one commission plan;
completing the following steps for each of the at least one commission plan, (i) finding sales figures for each of the variables comprising the commission rule by applying the component associated with each variable to the sales records, and (ii) solving the commission rule to thereby find the commissions; and
outputting the commissions.

2. The method of claim 1 wherein the step of receiving a request to calculate commissions comprises the step of:
receiving a request to calculate commissions for a specific instance; and wherein the step of selecting at least one commission plan comprises the step of:
selecting at least one commission plan from the plurality of commission plans, each of the at least one commission plan having commissions owing and calculable for a particular date range at the occurrence of the specific instance.

3. The method of claim 2 wherein the specific instance is chosen from a set of instances generated from a commission policy comprised of a user defined frequency and a user defined start date.

4. The method of claim 3 wherein the user defined frequency is chosen from the group consisting of weekly, bi-weekly, and monthly and the user defined start date is chosen from the group consisting of a date, Monday, Tuesday, Wednesday, Thursday, Friday, Saturday, and Sunday.

5. The method of claim 1 wherein each of the at least one commission plan further comprises a commission frequency, said commission frequency comprising a time interval, said time interval being equal in length to the particular date range and determining when the commissions for the commission plan become owing and calculable on a reoccurring basis.

6. The method of claim 5 wherein the commission frequency is selected from the group consisting of weekly, bi-weekly, and monthly.

7. The method of claim 1 wherein the sales records are gathered from one or more databases.

8. The method of claim 7 wherein the one or more databases contain data originating from an order entry system, billing system or any other source containing records for which commissions can be calculated.

9. The method of claim 8 wherein each of the sales records is further comprised of at least one of the following: a name, an employee id, a name of a product, a quantity of products sold, a work order type, a product code, a flag, a customer name, a net amount, a dollar amount, and a status.

10. The method of claim 1 wherein the at least one commission plan comprises a first commission plan and a second commission plan, the particular date range of the first and second commission plan being distinct.

11. The method of claim 1 wherein each component used as a data source for a variable is user defined.

12. The method of claim 11 wherein each component is capable of being used as a data source for a plurality of variables in a plurality of commission plans.

13. The method of claim 12 wherein the component is selected from the group consisting of a predefined function, a look-up table and a tiered look-up table.

14. The method of claim 13 wherein the predefined function is capable of performing a query on the sales records gathered for any commission plan.

15. The method of claim 15 wherein the query comprises at least one of the functions chosen from Sum, GROUP BY, and Where.

16. The method of claim 13 wherein the look-up table is comprised of a list of attributes and numerical values as defined by the user, each attribute being associated with one of the numerical values.

17. The method of claim 16 wherein the list of attributes is supplied by a master product list defined by the user.

18. The method of claim 13 wherein the tiered look-up table is comprised of a list of numerical ranges and numerical values, each numerical range being associated with one of the numerical values.

19. The method of claim 1 wherein each of the plurality of commission plans further comprises a list of primary recipients and the step of solving the commission rule comprises the step of:
solving the commission rule to thereby calculate the commissions of each of the primary recipients of each of the at least one commission plans.

20. The method of claim 19 wherein the at least one commission plan comprises a first commission plan and a second commission plan, the list of primary recipients for the first commission plan and the second commission plan being distinct.

21. The method of claim 19 wherein the list of primary recipients comprises at least one of the following: a name of a person, a name of a business, a name of a sales channel, a name of an independent contractor, and an identification code representing any of the previously named items.

22. The method of claim 1 further comprising the step of:
validating the sales records for completeness.

23. The method of claim 22 wherein the step of validating the sales records comprises the step of:
comparing the sales records to at least one master list, said master list chosen from a master product list and a master sales personnel list in a defined organizational hierarchy.

24. A method of calculating commissions based on a commission plan, said commission plan comprising a commission rule, said commission rule comprising a variable, said variable having a component as a datasource, said method comprising steps of:
providing sales records in a database table;
applying the component to database table thereby extracting sales figures;
supplying the sales figures to the variable;
solving the commission rule such that the commissions are calculated;
outputting the commissions in a usable format.

25. The method of claim 24 wherein the component has been previously defined by a user.

26. The method of claim 25 wherein the user defines the component through a graphical user interface.

27. The method of claim 25 wherein the user defines the component using a programming language to write computer code.

28. The method of claim 24 wherein the component is selected from the group consisting of a predefined function, a look-up table, and a tiered look-up table.

29. The method of claim 28 wherein the user defines the component through a graphical user interface.

30. The method of claim 28 wherein the predefined function is capable of performing a query on the database table, said database table comprising columns and rows, each column identified by a column name and comprising entries, each row comprising a sales record.

31. The method of claim 30 wherein the query comprises at least one function, the function chosen from a summing function, a grouping function, and a filtering function.

32. The method of claim 31 wherein the summing function is operative to sum the entries in one of columns, said column being selected by the user from a list of available columns provided by the graphical user interface.

33. The method of claim 32 wherein the grouping function is operative in conjunction with the summing function to sum the entries of a first column by the entries in at least one other column, said first and the at least one other column being selected by the user.

34. The method of claim 33 wherein the filtering function is operative to exclude sales records pursuant to criteria defined by the user.

35. The method of claim 34 wherein the criteria is defined by the user entering at least one of the following: the column name, a name of a field, a conditional operator, a name of a product, a numerical amount and a connector.

36. The method of claim 31 wherein the graphical user interface represents the summing function by the term SUM, the grouping function by the term GROUP BY, and the filtering function by the term WHERE.

37. The method of claim 28 wherein the look-up table is operative of awarding a dollar amount for each sale of a particular product, the look-up table comprising a list of products and associated dollar amounts, both the list of products and dollar amounts defined by the user.

38. The method of claim 36 wherein a master product list supplies the list of products.

39. The method of claim 36 wherein the look-up table relies on a predefined function as a data source to supply the values to be compared to the look-up table.

40. The method of claim 28 wherein the tiered look-up table is operative of awarding a dollar amount based upon a quantity of sales, the look-up table comprising a range of values and associated dollar amounts, both the range of values and dollar amounts determined by the user.

41. The method of claim 24 wherein the commission plan further comprises primary recipients, the primary recipients being determined by the user, and the sales figures extracted by the component comprising sales figures for each primary recipient.

42. The method of claim 40 wherein the primary recipients are selected from a list provided by a graphical user interface.

43. The method of claim 40 wherein the step of solving the commission rule further comprises the step of:
finding the commissions for each of the primary recipients.

44. The method of claim 24 wherein the step of providing the sales records further comprises the step of:
providing the sales records from a second database table based upon a commission frequency.

45. The method of claim 43 wherein the second database table comprises sales records from a billing system or an order entry system.

46. A method of calculating commissions on a reoccurring basis from a plurality of sales records stored in a first database, said plurality of sales records being continuously updated, the method comprising the steps of:
(A) defining a commission policy, said commission policy constraining the calculation of the commissions to specific instances;
(B) defining at least one commission plan, each of the at least one commission plan having commissions owing and calculable on a reoccurring basis;
(C) selecting a specific instance to calculate the commissions;
(D) determining which of the at least one commission plan has commissions owing and calculable for the specific instance;
(E) importing sales records for each commission plan having commissions owing and calculable from the first database table into a second database table;
(F) calculating the commissions, said commissions being determined by all of the at least one commission plan having commissions owing and calculable for the specific instance; and
(G) selecting a second instance to calculate commissions and completing the Steps (D), (E) and (F) the second instance.

47. The method of claim 45 further comprising the step of:
defining at least one component; and
wherein each of the at least one commission plan further comprises a commission rule, said commission rule comprising one or more variables, each variable having a component as a data source, a user selecting the component for each variable from the at least one component.

48. The method of claim 46 wherein each of the at least one component is selected by the user from the group consisting of: a predefined function, a look-up table and a tiered look-up table.

49. The method of claim 45 wherein the commission policy comprises a user defined frequency, the user defined frequency determining the specific instances.

50. The method of claim 45 wherein each of the at least one commission plan further comprises a list of primary recipients and Step (F) comprises the step of:
calculating the commissions for each of the primary recipients of each of the at least one commission plans having commissions owing and calculable.

51. The method of claim 45 further comprising the steps of:
creating a master product list; and
validating the completeness of the sales records loaded into the second database prior to the step of calculating the commissions.

52. A computer based method of calculating commissions, said method comprising steps of:
providing a graphical user interface to a user for data input;
receiving user preferences through said graphical user interface;
storing at least a portion of said user preferences in a table;
receiving a request to calculate commissions; and
retrieving and applying said user preferences stored in the table to sales records to thereby calculate the commissions.

53. The method of claim 51 wherein the user preferences comprise a first set of parameters and a second set of parameters, said first set of parameters defining a component and said second set of parameters defining a commission plan.

54. The method of claim 52 wherein the component is chosen from the group consisting of: a predefined function, a look-up table, and a tiered look-up table.

55. The method of claim 52 wherein said second set of parameters further define a commission rule, said commission rule comprising a variable, said variable receiving values from the component.

56. The method of claim 54 wherein second set of parameters further define primary recipients, said primary recipients receiving the benefit of the commission plan.

57. The method of claim 55 wherein the second set of parameters further define a commission frequency, said commission frequency, said commission frequency determining when the commissions for the commission plan become owing and calculable.

58. The method of claim 52 wherein the user preferences further comprise a third set of parameters, said third set of parameters defining a commission policy, said commission policy constraining the calculation of the commissions to specific instances.

59. A method of calculating commissions, said method comprising the steps of:
providing sales records;
applying a component to the sales records thereby extracting sales figures;
supplying the sales figures to a commission rule; and
calculating the commissions.

60. The method of claim 58 further comprising the step of:
providing a list of primary recipients, each of the primary recipient receiving commissions and the sales figures are grouped by the primary recipients.

61. The method of claim 58 wherein the commission rule is used to find the commissions due each of the primary recipients.

62. The method of claim 60 wherein the component is selected from the group consisting of a predefined function, a look-up table, and a tiered look-up table.

63. A method to calculate commissions, the method comprising the steps of:
creating a set of commission plans;
selecting at least one commission plan from the set of commission plans;
collecting sales records for each of the at least one commission plan;
calculating the commissions for the at least one commission plan; and
outputting the commissions.

64. The method of claim 62 wherein all of the steps are adapted to one or more computers.

65. The method of claim 62 further comprising the step of:
selecting a specific instance to calculate the commissions.

66. The method of claim 64 wherein the specific instance at least partially determines the at least one commission plan selected from the set of commission plans.

67. The method of claim 64 wherein each of the at least one commission plan defines a date range, said date range at least partially determining the sales records collected.

68. The method of claim 66 wherein the at least one commission plan is comprised of a first commission plan and a second commission plan.

69. The method of claim 69 wherein the first commission plan defines a first date range and the second commission plan defines a second date range, the sales records collected for the first commission plan spanning the first date range, and the sales records collected for the second commission plan spanning the second date range.

70. The method of claim 68 wherein the first date range and the second date range are the same or different.

71. The method of claim 68 wherein the sales records collected for the first commission plan are stored in a first import table and the sales records collected for the second commission plan are stored in a second import table.

72. The method of claim 70 wherein the first import table and the second import table are the same import table or different import tables.

73. The method of claim 67 wherein both the first and second commission plan each further comprise a commission rule, said commission rule comprising one or more variables, each of the variables receiving sales figures from a component.

74. The method of claim 72 wherein a first variable in the commission rule of the first commission plan receives values from a first component and a second variable in the commission rule of the second commission plan receives values from a second component.

75. The method of claim 73 wherein the first component and the second component are the same or different.

76. The method of claim 74 wherein the first component is chosen from the group consisting of a predefined function, a look-up table, and a tiered look-up table, and the second component is chosen from the list consisting of a predefined function, a look-up table, and a tiered look-up table.

77. The method of claim 67 wherein the first commission plan comprises a first list of primary recipients and the second commission plan comprises a second list of primary recipients, each recipient receiving commissions, if owing.

78. The method of claim 76 wherein the first list of primary recipients and the second list of primary recipients comprise the same primary recipients or different primary recipients.

79. A method of determining the commissions of a sales force on a hierarchal basis, said method comprising the steps of:
defining an organizational hierarchy for the sales force;
defining a commission plan, said commission plan comprising a list of primary recipients, each of the primary recipients receiving commissions based upon the sales of subordinates, said commission plan further comprising a commission rule;
determining the subordinates of each of the primary recipients from the organizational hierarchy after receiving a request to calculate commissions for a specific instance from the organizational hierarchy;
importing the sales records of the subordinates of each of the primary recipients to an import table;
applying the commission rule to the import table thereby determining the commissions of the primary recipients based upon the sales of the subordinates.

80. The method of claim 78 wherein the organizational hierarchy is created by using a graphical user interface.

81. The method of claim 79 wherein the list of primary recipients identifies a first primary recipient and a second primary recipient, the subordinates of the first primary recipient being distinct from the subordinates of the second primary recipient.

82. The method of claim 78 wherein the commission rule comprises a variable, the variable receiving values from a component and the step of applying the commission rule further comprises the step of:
applying the component to the import table to extract sales figures, said sales figures supplying the values to the variable.

83. The method of claim 81 wherein the import table comprises a plurality of import tables.

84. The method of claim 78 further comprising the step of:
modifying the organizational hierarchy after the step of creating the commission plan.

85. The method of claim 83 wherein the organizational hierarchy is independent of the commission plan.

86. A method of calculating sales commissions, the method comprising the steps of:
creating a commission plan, said commission plan defining at least one date range for which the commissions will be calculated; said commission plan further comprising a commission rule; said commission rule comprising a variable, said variable receiving data from a component;
selecting a first date range from the at least one date range and providing sales records for the first date range;
applying the component to the sales records of the first date range thereby extracting sales figures for the first date range;
applying the commission rule to the sales figures for the first date range such that the commissions for the first date range are calculated; and
outputting the commissions.

87. The method of claim 85 wherein the component is chosen from a predefined function, a look-up table and a tiered look-up table.

88. The method of claim 85 further comprising the steps of:
selecting a second date range from the at least one date range and providing sales records for the second date range;
applying the component to the sales records of the second date range thereby extracting sales figures for the second date range; and
applying the commission rule to the sales figures for the second date range such that the commissions for the second date range are calculated.

89. The method of claim 85 wherein the at least one date range is generated from a commission frequency.

90. A method of calculating commissions comprising the steps of:
identifying recipients of the commissions;
providing sales records for the recipients in a database table, the database table being organized into a plurality of columns, each column comprising entries;
manipulating the database table to thereby extract sales figures;
applying a commission rule to the sales figures to thereby calculate the commissions of each recipient; and
outputting the commissions.

91. The method of claim 89 wherein the step of manipulating the sales records is comprised of selecting a column in the database table and at least one of the following steps:
aggregating the entries of the column to find a sum;
grouping the sum by individual groups; and
filtering a portion of the sales records from consideration.

92. The method of claim 89 wherein the step of manipulating the sales records comprises the step of applying a query to the database table.

93. The method of claim 91 wherein the query is composed using a structured query language.

94. The method of claim 92 wherein the query is comprised of a SELECT function and at least one function chosen from SUM, GROUP BY, and WHERE.

95. The step of claim 91 further comprising the step of comparing the sales figures extracted by the query to a look-up table or a tiered look-up table to find sales totals and the step of applying a predetermined commission rule comprising the step of:
applying the predetermined commission rule to the sales totals to thereby calculate the commissions of each recipient.

96. A method of calculating commissions, the method comprising the steps of:
providing sales records;
providing at least one commission plan;
applying each of the at least one commission plan to the sales records; and
determining the commission.

97. The method of claim 95 wherein all of the steps are adapted to one or more computers.

98. The method of claim 96 wherein the step of providing sales records comprises the step of:
selecting the sales records from a plurality of sales records based upon a set of criteria.

99. The method of claim 97 further comprising the step of:
determining at least partially the set of criteria from the at least one commission plan.

100. The method of claim 97 wherein the plurality of sales records comprises billing records or order entry records.

101. The method of claim 95 wherein the sales records populate a first database table.

102. The method of claim 100 wherein the sales records have been imported from a second database table populated with billing records or order entry records.

103. The method of claim 95, wherein the step of providing sales records comprises the steps of:
searching a first database table populated with a plurality of sales records based upon a set of criteria;
selecting the sales records, each of the sales records meeting the set of criteria; and
importing the sales records to a second database table.

104. The method of claim 102 wherein the first database table comprises a plurality of sales records from a billing system or an order entry system.

105. The method of claim 102 wherein the first database table comprises a plurality of database tables.

106. The method of claim 102 wherein each of the at least one commission plan comprises an activation date, the activation date of each of the at least one commission plan at least partially determining the set of criteria.

107. The method of claim 102 wherein each of the at least one commission plan comprises a commission frequency, the commission frequency of each of the at least one commission plan at least partially determining the set of criteria.

108. The method of claim 102 wherein each of the at least one commission plan comprises a group of primary recipients, the group of primary recipients of each of the at least one commission plan at least partially determining the set of criteria.

109. The method of claim 102 wherein each of the at least one commission plan comprises primary recipients and at least one parameter chosen from an activation date and a plan frequency, the group of primary recipients and the at least one parameter at least partially determining the set of criteria.

110. The method of claim 95 wherein each of the at least one commission plan defines a plan class, the plan class determining whether the sales commission is based upon individual sales or the sales of others.

111. The method of claim 95 wherein each of the at least one commission plan comprises an activation date.

112. The method of claim 95 wherein each of the at least one commission plan comprises primary recipients.

113. The method of claim 95 wherein each of the at least one commission plan comprises a commission frequency, the commission frequency operative to determines when commissions become owing and calculable on a reoccurring basis.

114. The method of claim 112 wherein the commission frequency is further operative to determine a date range for which the commissions will be calculated.

115. The method of claim 95 wherein each of the at least one commission plan comprises a commission rule, said commission rule comprising a variable, said variable receiving values from a component.

116. The method of claim 95 wherein each of the at least one commission plan is comprised of a commission rule and primary recipients.

117. The method of claim 115 wherein each of the at least one commission plan is further comprised of a parameter, said parameter chosen from a commission frequency, a plan class, and an activation date.

118. The method of claim 115 wherein each of the at least one commission plan is further comprised of a parameter, said parameter chosen from an aggregation component and a component.

119. The method of claim 95 wherein each of the at least one commission plan is comprised of a plan class, an aggregation component, an activation date, primary recipients, a plan frequency, and a commission rule.

120. The method of claim 95 wherein the step of providing at least one commission plan comprises the step of:
selecting a specific instance to calculate commissions; and
selecting the at least one commission plan from a group of commission plans based at least partially on the specific instance.

121. The method of claim 119 wherein the specific instances are selected from a set of instances, the set of instances being determined from a commission policy.

122. The method of claim 120 wherein each commission plan in the group of commission plans is comprised of a plan status, the plan status selected from the group of active, inactive, and retired, and the step of selecting the at least one commission plan being further based at least partially on the plan status.

123. The method of claim 95 further comprising the steps of:
providing a master product list; and
validating the sales records for completeness.

124. A system for calculating commissions based a plurality of commission plans, each of the said commission plans comprising a commission rule, said commission rule comprising one or variables, each variable having a component as a data source, said system comprising:
an interface means for receiving a request to calculate commissions;
a selecting means for selecting at least one commission plan having commissions owing and calculable from the plurality of commission plans;
an import means for importing sales records for each of the commission plans having commissions owing and calculable;
an extraction means for applying each component of each of the at least one commission plan to the sales records to thereby extract sales figures;
a calculation means for solving the commission rule using the sales figures extracted from the sales records; and
a outputting means to display the commissions.

125. The system of claim 123 wherein the interface means receives a request to calculate commissions for a specific instance and the selecting means selects commission plans having commissions owing and calculable for the specific instance.

126. The system of claim 124 further comprising a generating means for generating a set of instances based upon a user defined frequency and start date, the specific instance being chosen from the set of instances.

127. The system of claim 125 wherein the user defined frequency is chosen from the group consisting of weekly, bi-weekly, and monthly and the start date is chosen from the group consisting of a date, Monday, Tuesday, Wednesday, Thursday, Friday, Saturday, and Sunday.

128. The system of claim 123 wherein each of the at least one commission plan further comprises a commission frequency, said commission frequency comprising a time interval, said time interval being equal in length to the particular date range and determining when the commissions for the commission plan become owing and calculable on a reoccurring basis.

129. The system of claim 127 wherein the commission frequency is selected from the group consisting of weekly, bi-weekly, and monthly.

130. The system of claim 123 wherein the import means imports the sales records from one or more databases.

131. The system of claim 129 wherein the one or more databases contain sales records originating from an order entry system, a billing system or any other source containing sales records for which commissions can be calculated.

132. The system of claim 130 wherein each of the sales records is comprised of at least one of the following: a name, an employee id, a name of a product, a quantity of products sold, a work order type, a product code, a flag, a customer name, a net amount, a dollar amount, and a status.

133. The system of claim 123 wherein each component is selected from the group consisting of a predefined function, a look-up table and a tiered look-up table.

134. The system of claim 132 wherein the predefined function is operative to perform a query on the sales records gathered for any commission plan and the extraction means applies the query to the sales records to thereby extract the sales figures.

135. The system of claim 133 wherein parameters of the predefined function are stored in a table and the extraction means creates the query from the parameters contained in the table and then applies the query to the sales records to extract the sales figures.

136. The system of claim 134 wherein the extraction means appends a name or sales id to the query prior to applying it to the sales records in order to filter any records not pertaining to the name or sales id.

137. The system of claim 135 wherein the extraction means further appends a date range to the query prior to applying it to the sales records, said date range comprising the date range for which the commissions are owing and calculable for the commission plan to which the predefined function pertains.

138. The system of claim 123 wherein the extraction means applies a predefined function serving as a source to a look-up table or a tiered look-up table to the sales records to thereby extract the sales figures.

139. The system of claim 137 wherein the predefined function is operative to perform a query on the sales records gathered for any commission plan and the extraction means applies the query to the sales records to thereby extract the sales figures.

140. The system of claim 138 wherein parameters of the predefined function are stored in a table and the extraction means creates the query from the parameters contained in the table and then applies the query to the sales records to extract the sales figures.

141. The system of claim 139 wherein the extraction means appends a name or sales id to the query prior to applying it to the sales records in order to filter any records not pertaining to the name or sales id.

142. The system of claim 140 wherein the extraction means further appends a date range to the query prior to applying it to the sales records, said date range being the date range for which the commissions are owing and calculable for the commission plan to which the predefined function pertains.

143. The system of claim 140 wherein the name or sales id appended to the query by the extraction means is a primary recipient or a subordinate of a primary recipient.

144. The system of claim 123 further comprising a validating means for validating the completeness of the sales records, said validating means comparing a master product list to the sales records.

145. A system to calculate commissions based on a commission plan, said commission plan comprising a commission rule, said commission rule comprising a component, the system comprising:
an import means for providing sales records in a first database table;
an extraction means for applying the component to the database table thereby extracting sales figures into a second database table;
a calculating means for solving the commission rule such that the commissions are calculated from the second database table, said commissions being stored in a third database table; and
an outputting means for displaying the commissions in the third database table.

146. The system of claim 144 further comprising an interface means for receiving user input, said user input comprising parameters to define the commission plan and the commission rule, said parameters being stored in a fourth database table.

147. The system of claim 145 wherein the user input further comprises parameters to define the component, said parameters being stored in a fifth database table.

148. The system of claim 146 wherein the interface means is a graphical user interface.

149. The system of claim 146 wherein the extraction means assembles a query from at least a portion of the parameters defining the component in the fifth database table and then applies the query to the first database table, the results of the query being stored in the second database table.

150. The system of claim 148 wherein the parameters comprise an aggregation column and optionally a GROUP BY clause and a WHERE clause.

151. The system of claim 148 wherein the calculating means forms an arithmetic expression for each row in the second database table pursuant to the commission rule and solves the arithmetic expression and stores the results in the third database table.

152. The system of claim 150 wherein the calculating means compares an entry in each of the rows of the second database table to a look-up table or a tiered look-up table and awards a value based upon that comparison.

153. The system of claim 151 wherein parameters defining the look-up table or tiered look-up table are stored in a seventh database table.

154. The system of claim 144 further comprising an interface means for receiving user input, said user input comprising a master product list, said master product list being stored in a fourth database table, and the system further comprising a validating means for validating the completeness of the sales records, said validating means comparing the master product list in the fourth database table to the sales records in the first database table.

155. A system for calculating commissions on a reoccurring basis from a plurality of sales records stored in a first database table, said plurality of sales records being continuously updated, the system comprising:
an interface means for accepting user input to define a commission policy and at least one commission plan, each of the at least one commission plan having commissions owing and calculable on a reoccurring basis, said interface means further capable of receiving a request from a user to calculate commissions for a specific instance chosen from a plurality of specific instances;
a selecting means for selecting commission plans having commissions owing and calculable for the specific instance from the at least one commission plan; and
an import means for providing sales records in a second database table for each commission plan having commissions owing and calculable for the specific instance from the plurality of sales records in the first database table; and
a calculation means for calculating the commissions for the specific instance.

156. The system of claim 154 wherein the interface means is further capable of receiving user input to define at least one component and each of the at least one commission plan further comprises a commission rule, said commission rule comprising one or more variables, each variable having a component as a data source, said interface means allowing a user to select the component for each variable from the at least one component.

157. The system of claim 155 wherein each of the at least one component is defined by the user as a predefined function, a look-up table or a tiered look-up table.

158. The system of claim 154 wherein the interface means is further capable of receiving user input to define a Commission policy, and the system further comprises a generation means for generating the plurality of specific instances from the commission policy.

159. The system of claim 154 wherein the interface means is further capable of receiving user input to define a list of primary recipients for each of the at least one commission plan and the calculating means is further capable of calculating the commissions for each of the primary recipients of each of commission plans having commissions owing and calculable for the specific instance.

160. A system for calculating commissions, said system comprising:
an import means for providing sales records;
an extraction means for applying a component to the sales records thereby extracting sales figures the sales records;
a calculation means for supplying the sales figures to a commission rule and solving the commission rule to thereby calculate the commissions; and
a outputting means for displaying the commissions.

161. The system of claim 159 further comprising an interface means for accepting user input to define a list of primary recipients.

162. The system of claim 160 wherein the extracting means is further capable of applying the component to the sales records for each of the primary recipients and thereby extracting sales figures for each of the primary recipients.

163. The system of claim 161 wherein the calculation means is further capable of supplying the sales figures to the commission rule and solving the commission rule for each of the primary recipients to thereby calculate the commissions for each of the primary recipients.

164. The system of claim 161 wherein the component is selected from the group consisting of a predefined function, a look-up table, and a tiered look-up table.

165. A system for determining the commissions of a sales force on a hierarchal basis, said system comprising:
an interface means for accepting user input to define an organizational hierarchy for the sales force and a commission plan, said commission plan comprising a list of primary recipients, each of the primary recipients receiving commissions based upon sales of subordinates, said commission plan further comprising a commission rule;
a determining means for determining the subordinates of each of the primary recipients from the organizational hierarchy after receiving a request to calculate commissions for a specific instance;
an importing means for providing sales records of the subordinates of each of the primary recipients;
a calculating means for applying the commission rule to the sales records thereby determining the commissions of the primary recipients based upon the sales of the subordinates.

166. The system of claim 164 wherein the interface means is a graphical user interface.

167. The system of claim 164 wherein the commission rule comprises a variable, the variable receiving values from a component, the component being defined by the user input.

168. The system of claim 166 wherein the component comprises a query, said calculating means further capable of appending the query to only include sales records of the subordinates.

169. The system of claim 167 wherein the interface means is further capable of receiving additional user input to modify the organizational hierarchy after the commissions have been calculated.
